(19) United States
(12) Patent Application Publication
(10) Pub. No.: US 2013/0260089 A1
(43) Pub. Date: Oct. 3, 2013

(54) BODY FORMED OF REFRACTORY MATERIAL HAVING STRESS RELIEF SLITS AND METHOD OF FORMING THE SAME

(71) Applicant: REFRACTORY SPECIALTIES, INC., Sebring, OH (US)

(72) Inventors: Gregory J. GORBY, Hanoverton, OH (US); Dale R. SAARI, New Springfield, OH (US)

(21) Appl. No.: 13/852,839

(22) Filed: Mar. 28, 2013

Related U.S. Application Data
(60) Provisional application No. 61/616,743, filed on Mar. 28, 2012.

(51) Int. Cl. C04B 38/00; C04B 40/00

(52) U.S. Cl. CPC C04B 38/0093; C04B 38/0006; C04B 40/0089
USPC 428/116; 428/167; 264/571

(57) ABSTRACT

The present invention is directed to a body formed of a refractory material and a method of forming a refractory body. The body formed of a refractory material comprises a plurality of slits formed into one of its surfaces. The slits relieve thermal stress in the body and prevent cracking that would otherwise occur. In one embodiment, the invention can be a body formed of a refractory material comprising: a first surface and an opposing second surface; and a pattern of stress relief slits formed into at least one of the first and second surfaces of the body.

### CROSS-REFERENCE TO RELATED APPLICATIONS

The present application claims the benefit of U.S. Provisional Patent Application Ser. No 61/616,743, tiled Mar. 28, 2012, the entirety of which is incorporated herein by reference.

### FIELD OF THE INVENTION

The present invention relates generally to a body formed of a refractory material, and more specifically to a body formed of a refractory material comprising slits formed therein for thermal stress relief.

### BACKGROUND OF THE INVENTION

Refractory materials are those that retain strength and shape without softening at high temperatures such that they are applicable for structures, or as components of systems, that are exposed to high temperature environments. Structures such as bodies, boards, and the like formed of refractory material are used under extremely high heat environments, such as for lining of furnaces, kilns, converteis, tanks, crucibles, ladles, combustion chambers and the like. Due to the nature of furnace and kiln operation, these structures formed from refractory materials are subjected to extremely high temperature environments when the furnace or kiln is powered and much lower temperatures when the furnace or kiln is not powered.

These large variations in temperature result in uneven expansion and contraction within the mass of the refractory material, and leads to the development of uneven stresses and strains. As a result, the variations in temperature cause the refractory material to spall or crack due to the repeated expansion and contraction of the material. Thus, a need exists to reduce or altogether eliminate the cracks that appear in structures formed of refractory materials that occur due to thermal stresses on the material.

### SUMMARY OF THE INVENTION

The present invention is directed to a body formed of a refractory material and a method of forming the same. The refractory material comprises a pattern of slits formed therein for thermal stress relief. The pattern of slits may comprise slit segments, continuous slits, or combinations thereof. In certain embodiments the slits may extend across an entirety of a surface of the body and in other embodiments the slits may extend only over portions of the surface of the body. The slits may be formed in only one surface of the body or in multiple opposing surfaces.

In one aspect, the invention can be a body formed of a refractory material comprising: a first surface and an opposing second surface; and a pattern of stress relief slits formed into at least one of the first and second surfaces of the body.

In another aspect, invention can be a body formed of a refractory material comprising: a first surface and an opposing second surface; and a plurality of stress relief slits formed into one of the first and second surfaces of the body, the plurality of stress relief slits intersecting one another to divide the one of the first and second surfaces of the body into a plurality of polygonal sections.

In yet another aspect, the invention can be a method of forming a refractory body having stress relief slits, the method comprising: a) forming an aqueous slurry comprising water, refractory material fibers, and a binder; b) dehydrating the aqueous slurry by applying a vacuum to the aqueous slurry thereby forming the refractory body, the refractory body having a first surface and an opposite rear surface; and c) forming a plurality of stress relief slits into at least one of the first and second surfaces of the refractory body.

Further areas of applicability of the present invention will become apparent from the detailed description provided hereinafter. It should be understood that the detailed description and specific examples, while indicating the preferred embodiment of the invention, are intended for purposes of illustration only and are not intended, to limit the scope of the invention.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 a schematic illustration of the formation of an aqueous slurry in a tank used to form a body of refractory material according to one embodiment of the present invention;

FIG. 2 is a schematic illustration of the aqueous slurry formed in the tank of FIG. 1;

FIG. 3 is a schematic illustration of the tank of FIG. 1 having a mold and a screen positioned therein, wherein a vacuum is applied to the aqueous slurry to dehydrate the aqueous sluny;

FIG. 4 is a schematic illustration of the body being formed within the mold due to the vacuum from the process step of FIG. 3;

FIG. 5 is a perspective view of the body formed in the process step FIG. 4 and removed from the tank;

FIG. 6 is a diagram illustrating contraction of the body or FIG. 5 that occurs during hot and cold cycles;

FIG. 7A is a perspective view of the body of FIG. 5 with a. first pattern of stress relief slits formed into a surface thereof;

FIG. 7B is a perspective view of the body of FIG. 5 with a second pattern of stress relief slits formed into a surface thereof;

FIG. 7C is a schematic cross-sectional view taken along line. VIIC-VIIC in FIG. 7A;

FIG. 7D is a perspective view of the body of FIG. 5 with a third pattern of Stress relief slits formed into a surface thereof;

FIG. 7E is a perspective view of the body of FIG. 5 with a fourth pattern of stress relief slits formed into a surface thereof;

FIG. 8 is a perspective view of a die that is used to form the pattern of stress relief slits of FIG. 7A;

FIG. 9 is a schematic illustration of the aqueous slurry within the tank with a mold and a screen positioned therein, wherein the die of FIG. 8 is positioned atop the screen:

FIGS. 10-12 illustrate equipment used during experiments testing the body of the present invention;

FIG. 13 illustrates deflection of a hod during experimental testing;

FIG. 14 illustrates an interior of the equipment of FIGS. 10-12 showing the thermocouples;

FIG. 15 illustrates the fully assembled testing equipment prior to experimental use;

FIG. 16 illustrates the filly assembled testing equipment in operation with a first body installed for testing;

FIGS. 17 and 18 illustrate the cracking on the first body after testing;

FIGS. 19 and 20 are graphical representations of the hot face temperature vs. deflection of the first body;

FIG. 21 illustrates the first body with a slit pattern formed therein prior to testing thereof;

FIG. 22 illustrates the first body after testing;

FIGS. 23 and 24 are graphical representations of the hot face temperature vs. deflection of the first body of FIG. 21 with the slit pattern;

FIG. 25 illustrates a second body with no slit pattern after testing;

FIG. 26 illustrates the second body with a slit pattern after testing;

FIG. 27 is a close-up view of the second body of FIG. 26;

FIGS. 28 and 29 are charts illustrating the temperature vs. deflection of the second body of FIG. 25 with no slit pattern;

FIGS. 30 and 31 are charts illustrating the temperature vs, deflection of the second body of FIG. 26 with a slit pattern;

FIG. 32 is a chart illustrating the relative amounts of deflection of the second body both with and without the slit pattern;

FIGS. 33 and 34 illustrate a third body with a discontinuous slit pattern after testing;

FIGS. 35 and 36 are charts illustrating the temperature vs. deflection of the third body of FIGS. 33 and 34;

FIG. 37 is a table illustrating the results of measuring deflection with the bodies of FIGS. 25, 26 and 33;

FIG. 38 illustrates a fourth body with no slit pattern after testing;

FIG. 39 is a close-up view of the cracking on the fourth body of FIG. 38 after testing;

FIGS. 40 and 41 are charts illustrating the temperature vs. deflection of the fourth body of FIGS. 38 and 39;

FIG. 42 illustrates a steel frame built to prevent as much deflection of the bodies during testing as possible;

FIGS. 43 and 44 illustrate a fifth body with no slit pattern after testing with the steel frame in place;

FIGS. 45 and 46 illustrate the fifth body with a slit pattern after testing with the steel frame in place;

FIG. 47 illustrates a sixth body with no slit pattern after testing;

FIG. 48 illustrates the sixth body with a slit pattern after testing;

FIG. 49 is a close-up view of the sixth body of FIG. 47;

FIG. 50 is a close-up view of the sixth body of FIG. 48;

FIGS. 51 and 52 are charts illustrating the temperature vs. deflection of the sixth body of FIG. 47;

FIGS. 53 and 54 are charts illustrating the temperature vs. deflection of the fourth body of FIG. 48;

FIGS. 55-56 illustrate a sixth body without a slit pattern when the screen side being used as the hot face;

FIGS. 57 and 58 illustrate the sixth body of FIGS. 55-56 when the fill side is used as the hot face;

FIGS. 59 and 60 illustrate the sixth body of FIGS. 55-56 with a 1″×1″ grid of slits after testing;

FIG. 61 illustrates the sixth body of FIGS. 55-56 with a 2″×2″ slit pattern after testing;

FIG. 62 and 63 illustrates the sixth body of FIGS. 55-56 with a 4″×4″ slit pattern after testing;

FIGS. 64-66 illustrate the sixth body of FIGS. 55-56 with one horizontal slit and one vertical slit centered to the heated area of the body after testing.

### DETAILED DESCRIPTION OF THE INVENTION

The description of illustrative embodiments according. to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below_{:}” “up,” “down,” “left,” “right,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected.” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combinations of features that may exist alone or in other combinations of features; the scope of the invention being defined by the claims appended hereto.

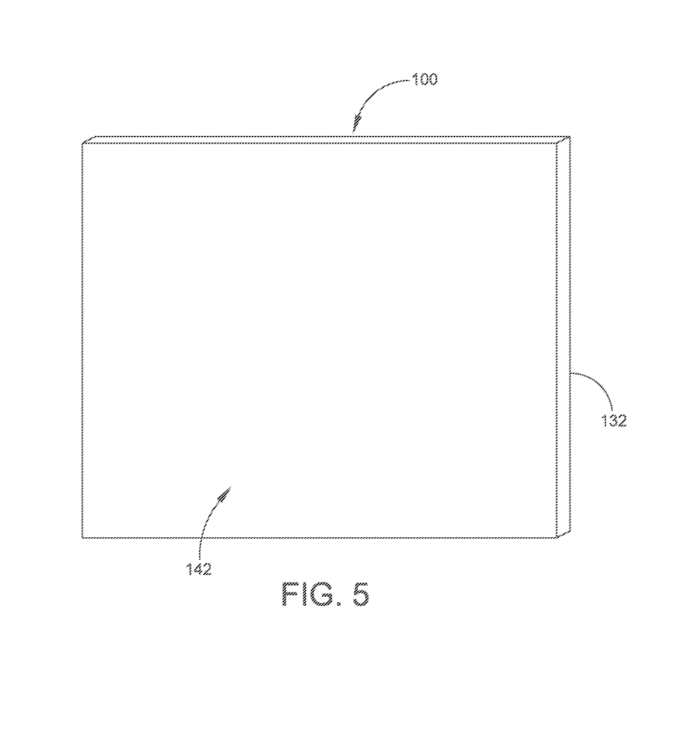

The invention will be described herein in relation to a body 100 (see FIG. 5) formed of a refractory material. A refractory material is one which retains its strength and is chemically and physically stable at high temperatures. Due to being formed of a refractory material, the body 100 is intended to retain its strength and shape without softening at high temperatures such that the body 100 is applicable for structures, or as components of systems, that are exposed to high temperature environments. The body 100 is used under extremely high heat environments, such as for lining of furnaces, kilns, incinerators. reactors, converters, tanks, crucibles, ladles and the like.

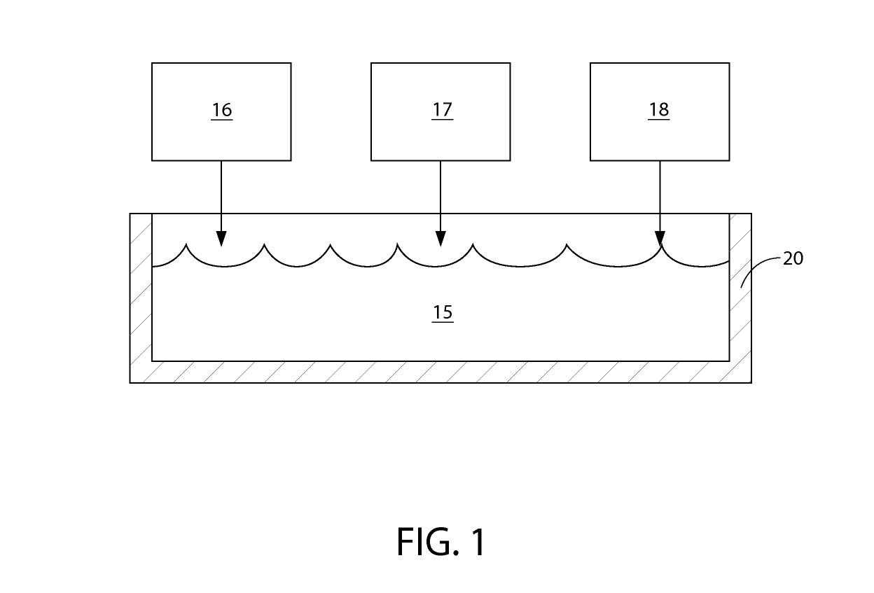

As used herein, the term “body” is not limited to any specific dimensions or relative dimensions, unless specifically recited in the claims. Thus, in certain embodiments the body 100 may comprise two opposing major surfaces both being substantially flat, planar surfaces such as that illustrated in FIG. 5, However, the invention is not to be so limited and in other embodiments the body 100 may comprise one or more rounded or arcuate major surfaces. Furthermore, although in the embodiment of the body 100 illustrated in FIG. 5 the body 100 has straight, flat edges, the invention is not to be so limited and the edges of the body 100 can be curved, arcuate, wavy, undulated or the like. The body 100 can thus he formed to have any desired shape depending upon its desired use. The shape of the body 100 can be altered during its formation as discussed in more detail below with reference to FIGS. 1-5. For example, if the body 100 is to be used in a combustion chamber, the body 100 may need to be rounded or arcuate to fit therein. If the body is used in a kiln, the body 100 may have one or more flat surfaces. The use to which the body 100 is to be put dictates its size and shape and thus is non-limiting of the present invention in all embodiments. It should be understood that the use of the terms “first surface” and “second surface” may refer to inner surfaces and outer surfaces, front surfaces and rear surfaces, top surfaces and bottom surfaces, and the like.

In the exemplified embodiment, the body 100 is a substantially rigid structure. Specifically, in the refractory industry there are blanket-type materials that can be rolled up or folded and more rigid materials that cannot be rolled up or folded. Materials having different characteristics in this regard are used for different purposes and to withstand different heat levels. Furthermore, different materials are used for different applications requiring greater and lesser temperature differences between the hot and cold cycles. The body 100 of the present invention is a rigid body that can not be rolled up or folded. Although described herein as being rigid, it should be appreciated that the body 100 may be able to bend slightly when pressure is applied thereto. However, if excessive pressure is applied to the body 100 it will snap or break into two separate pieces rather than fold upon itself.

Rigid structures funned of refractory material have been known to crack due to unequal thermal expansion that occurs during, their use. in the field, it is generally believed that a harder, more rigid refractory structure is better. However, the harder the refractory material is, the less resistant to thermal shock it is, and the more likely it is to crack during use. The body 100 of the present invention overcomes these problems and prevents cracking as will be discussed in more detail below. Thus, utilizing the techniques described herein bodies formed of refractory materials can be made more rigid while still preventing cracking.

The manner of forming the body 100 will now be described with specific reference to FIGS. 1-5. In one embodiment, the body 100 is formed from a refractory material that comprises a mixture of refractory material fibers, colloidal silica and an inorganic binder (i.e., clay). In certain embodiments, the refractory material fibers may be alumina silica fibres, although the invention is not to be so limited in all embodiments. In one such embodiment, the refractory material (and thus the body 100) comprises by weight about 60% to 80% silica, 15% to 35% alumina, and 2% to 10% of an inorganic. binder. The preferred inorganic, binder is a clay binder that is included at 5% by weight. Other inorganic binders include synthetic polymeric hinders, such as phenol formaldehyde and urea-formaldehyde and can be used in conjunction with or in lieu of a clay binder.

In another embodiment, the refractory material is formed from a mixture of refractory material fibers (such as alumina silica fibres), colloidal silica and an organic. binder. In one such embodiment, the refractory material (and thus the body 100) comprises by weight about 30% to 40% silica, 50% to 70% alumina, and 2% to 10%, or more preferably 4% to 8%, of an organic binder. Suitable organic binders include naturally occurring polymeric, materials such as starch (potato or corn), latex, tree gum and the like.

Other suitable binders may include a colloidal suspension of oxides, metals and non-metals such as alumina zirconia, titania and so forth. Binders are typically available as water-based or oil-based liquids. However, the amount of the binders in the refractory material is expressed as a solid weight.

Referring now to FIGS. 1-5, the formation of the body 100 using a casting process, and more specifically a vacuum process, will be described according to one embodiment of the present invention. It is to be understood, however, that in other embodiments of the present invention the body 100 can be formed according to other manufacturing methods known in the art for bodies formed of refractory material, such as refractory boards, including without limitation pressing, molding, weaving, milling, or combinations thereof.

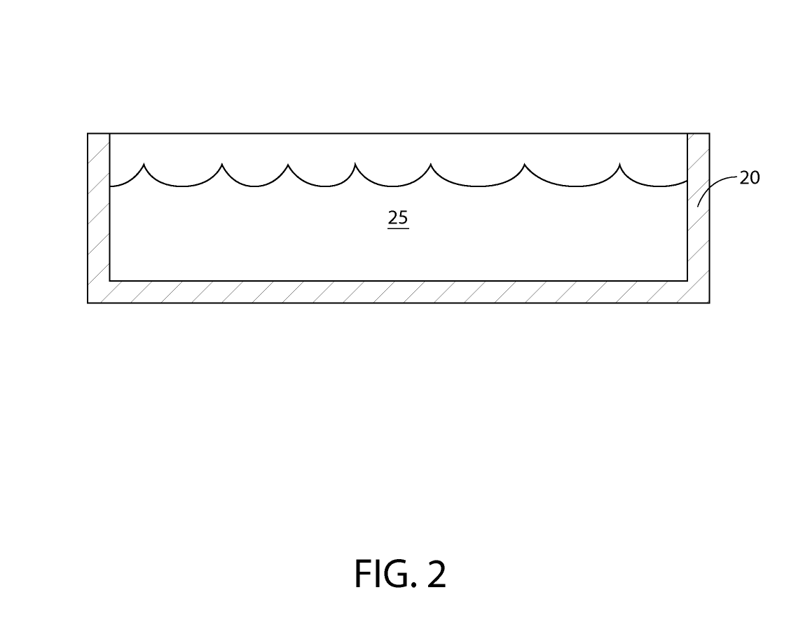

Referring now to FIG. 1 a bath of water 15 is initially drawn into a tank, reservoir, bath or other structure 20. The tank 20 can be an type of structure that is capable of holding a large quantity of a liquid or a slurry and that can be used to form the body 100 as will be described herein below. Once the bath of water 15 is drawn, an amount of silica fibres 16, an amount of colloidal silica 17 and an amount of a clay binder 18 is added to the bath of water 15 to form a bath of an aqueous slurry 25 (FIG. 2), It should be understood that when the body 100 is organic, the clay binder 18 is replaced with the proper amount of an organic binder, such as starch as has been described herein above.

In one specific embodiment when the body is formed from an organic batch, the bath of water 15 is in a range of about 750 to 1250 gallons, the amount of silica fibres 16 is in a range of about 100 to 150 pounds, the amount of colloidal silica 17 is in a range of about 15 to 25 pounds, and an amount of an organic binder 18 is in a range of about 3 to 10 pounds. Of course, the exact amounts of the materials being added to the bath of water 15 can vary depending on the desired resulting characteristics of the body 100 and/or the refractory material. Moreover, the identity of the materials may also vary depending on the desired make-up of the body 100 and/or the refractory material.

In one alternate embodiment when the body is formed from an inorganic batch, the batch may include between 300-700 gallons of water, between 200-400 gallons of colloidal silica, between 60-90 pounds of fibres, and between 6-10 pounds of clay binder. Again, the exact amounts of the materials being added to the bath of water 15 can vary depending on the desired resulting characteristics of the body 100 and/or the refractory material.

Referring now to FIG. 2, once the amount of silica fibres 16, the amount of colloidal silica 17 and the amount of a clay binder 18 have been added to the bath of water 15 and mixed, an aqueous slurry 25 results and forms in the tank 20. In one embodiment, the aqueous slurry 25 is about 1 to 3% by weight solids. Of course, other percentages are possible. The aqueous shirty 25 in certain embodiments may have a depth of between 36 to 48 inches and a width of between 96 to 108 inches. Of course, the invention is not to be limited by the depth and width of the aqueous slurry 25 in the tank 20 in all embodiments.

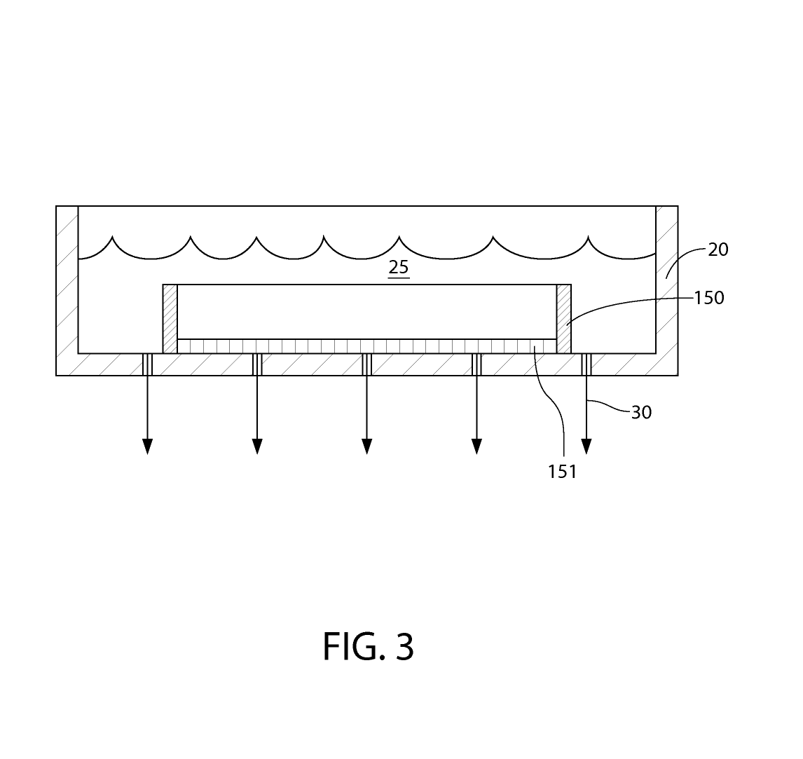

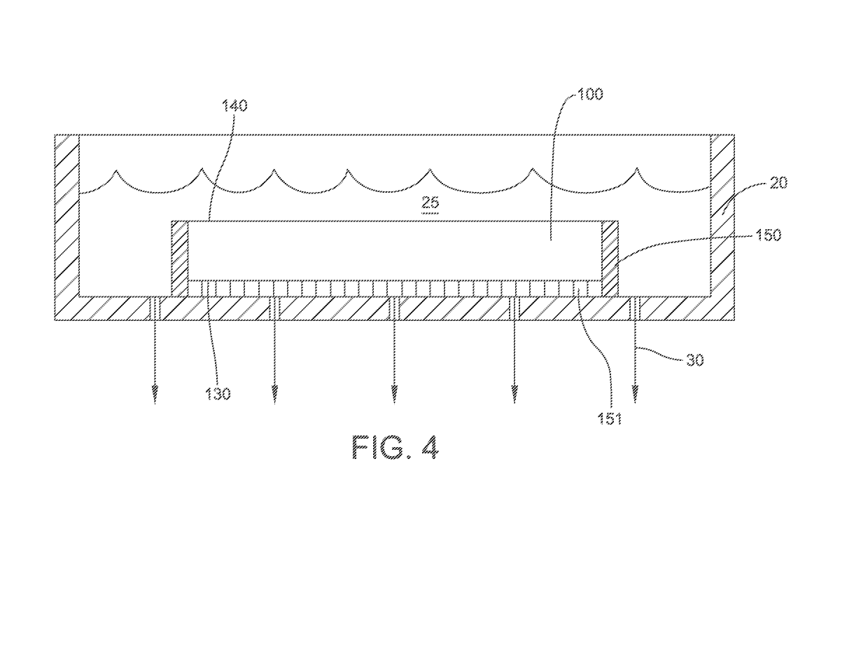

Referring to FIG. 3, after the aqueous slurry 25 is formed a mold 150 within which the body 100 is formed is placed at the bottom of the slurry 25, in certain embodiments, the mold 150 may be formed integrally with the tank 20, or the mold 150 may be a separate component from the tank 20, but positioned within the tank 20 before the formation of the aqueous slurry 25. The mold 150 is sized and shaped to the desired size and shape of the body 100 that is formed. Specifically, using the method described herein the body 100 is formed within the mold 150 such that the body 100 has the same size and shape (in terms of length, width and general polygonal shape) as the mold 150. However, the thickness of the body 100 is dependent upon the length of time that a vacuum runs as will be discussed in more detail below with reference to FIG. 4, and thus generally the mold 150 does not affect the thickness of the body 100 formed therein.

Although described herein as being placed onto the bottom of the slurry 25 after formation thereof, in other embodiments the mold 150 can be positioned on the bottom of the tank 20 prior to drawing the bath of water 15 into the tank 20 and thus prior to forming the slurry 25 in the tank 150. Furthermore, a die screen 151 is positioned on the bottom of the tank 20 within the mold 150. In the exemplified embodiment, the die screen 151 is a fine mesh screen.

Referring now to FIGS. 3 and 4 concurrently, formation of the body 100 in conformal size and shape with the size and shape of the mold 150 will be described. After the aqueous slurry 25 is formed in the tank 20, a vacuum 30 (illustrated as arrows) is applied to the aqueous slurry 25 through the die screen 151, thereby dehydrating a portion of the aqueous slurry 25. In one embodiment, the vacuum 30 is applied while the aqueous slurry 25 is maintained at approximately room temperature. In an alternate embodiment, the aqueous slurry 25 can be dehydrated in other manners, including without limitation heating. The vacuum applied is a very light vacuum pressure, which dehydrates the portion of the aqueous slurry 25 positioned within the confines of the mold 150 over time.

Referring now to FIG. 4, the mold 150 is illustrated in the slurry 25 with the body 100 formed therein due to the application of the vacuum 30 through the die screen 151. Thus, dehydration of the aqueous slurry 25 via vacuum results in the formation of the body 100 within the mold 150. Specifically, as the liquid within the mold 150 is dehydrated, the fiber, colloidal silica and binder harden to form the rigid body 100. In FIG. 4, the vacuum 30 is illustrated as still continuing such that creation of the body 100 is not yet complete. As will be described below, the length of time that vacuum 30 is applied directly affects the thickness of the body 100 that is thereby created. The body 100 comprises a screen side 130 and a fill side 140. Specifically, the surface of the body 100 that is adjacent the die screen 151 is the screen side 130 of the body 100 and the opposing surface of the body 100 is known as the fill side 140.

Typically, the screen side 130 of the body 100 is rougher than the fill side 140 of the body 100. The body 100 has a density in a range of about 10 to 25 pounds per cubic feet, and in a more preferred embodiment in a range of between about 14 to 18 pounds per cubic feet. However, in another embodiment the body 100 has a density in a range of about 20-24 pounds per cubic feet. In still other more encompassing embodiments, the body 100 may have a density of between approximately 8 pounds per cubic foot and approximately 45 pounds per cubic foot. The body 100 is less dense and softer in the center.

It should be appreciated that in certain embodiments the densities of the body 100 described above are average densities of the overall body 100 because the density of the body 100 is not homogeneous. Specifically, in certain embodiments the screen side 130 of the body 100 is between 10-20%, and more preferably between 12-15% denser than the fill side 140 of the body 100. This is due, at least in part, to gravity pulling the silica fibers downward towards the screen side 130 during the formation process such that by the time the materials begin to harden to form the body 100, more of the fibers are located near the screen side 130 than near the fill side 140. In certain embodiments, there is a density gradient that increases gradually from the fill side 140 to the screen side 130 of the completed body 100 of refractory material. Thus, the body 100 has a first density at the screen side 130 and a second density at the fill side 140, the first density being greater than the second density.

As discussed above, in certain non-limiting embodiments the slurry 25 has a depth of between 3-4 feet and a width of between 8-9 feet. As noted above, the length of time that the vacuum remains powered on determines and controls the depth of the resulting body that is formed (i.e., the longer the vacuum is on, the thicker the body 100). After the desired body thickness is achieved, the mold 150 is raised out of the slurry 25, put onto a drying rack, and placed in a drier to dry and form the body 100. A large quantity of the slurry 25 that does not dehydrate and form the body 100 remains in the tank 20 to form another body 100. Thus, the slurry 25 can be used to form more than one body 100.

In certain embodiments it is desirable to further harden the body 100 after formation thereof as described above. In certain such embodiments, the body 100 can be dipped hack into a hinder after formation. Specifically, in certain embodiments the fully formed body 100 can be dipped into a tank of colloidal silica. However, along, with hardening the body 100, this also decreases the ability of the body 100 to withstand thermal stress because the harder and more rigid the body 100, the more likely the body 100 is to crack due to thermal Stresses that occur during use.

The body 100 described herein can be used to line furnaces, kilns, converters, tanks, crucibles, ladles and other applications where a material that can maintain its shape and rigidity under high temperatures is desired. As used herein, high temperatures include temperatures that exceed 1000° F., more preferably temperatures that are between about 1000° F. and about 2500° F., still more preferably temperatures that are between about 1500° F. and about 2300° F. in certain embodiments, the high temperatures are between about 1500° F. and about 1800° F., and in certain other embodiments the high temperatures are between about 2100° F. and 2300° F., depending on the particular application of the body 100.

Referring, to FIG. 5, the body 100 is illustrated after formation thereof and after an optional final colloidal silica/hinder dip as discussed above. In the exemplified embodiment, the body 100 is a rigid board-shaped material having a first surface 142 and an opposing second surface 132. The use of the terms “first surface” and “second surface.” are not to be limiting herein. Specifically, in certain embodiments the first surface 142 may be the screen side 130 of the body 100 and in other embodiments the first surface 142 may be the fill side 140 of the body. Thus, it follows that in certain embodiments the second surface 132 may be the fill side 140 of the body 100 and in other embodiments the second surface 132 may be the screen side 130 of the body 100.

During use of the body 100, one of the first or second surfaces 142, 132 of the body 100 is used as the hot side of the body 100 and the other of the first or second surfaces 142, 132 of the body 100 is used as the cold side of the body 100. The hot side of the body 100 is the side of the body 100 that is adjacent to or sometimes in contact with the flame or fire of the kiln, furnace, convener or the like. The cold side of the body 100 is the side of the body 100 opposite the hot side of the body 100. In some applications the screen side 130 can be used as the hot side and the fill side 140 can be used as the cold side. in other applications the screen side 130 can he used as the cold side and the fill side 140 can be used as the hot side. Determining which side to use as the cold and hot sides can be a matter of preference in some embodiments. However, in certain embodiments it should be appreciated that the fill side 140, due to its lower density, is better able to withstand the thermal transients/stresses without cracking; and thus often the till side 140 is used as the hot side. As noted above, as used herein, unless otherwise specified, the first. surface 142 of the body 100 can refer to the screen side 130 or the fill side 140, and also either the hot side or the cold side. Similarly, the second surface 132 of the body 100 can refer to the screen side 130 or the fill side 140, and also either the hot side or the cold side.

In the embodiment of the body 100 exemplified in FIG. 5, the body 100 is a rectangular-shaped board having opposing flat surfaces and four flat edges. However, the invention is not to be so limited. The shape the body 100 is determined, based on the shape of the mold 150 that is used during the vacuum forming process. Thus, the shape of the body 100 is not to be limiting of the invention unless so specified in the claims, and it should be appreciated that the body 100 can take on any desired shape to satisfy any desired application or use of the body 100. In certain embodiments, the body 100 is used as a single piece combustion chamber. in such embodiments, the first surface may be the inner surface and the second surface may be the outer surface. Furthermore, in such an embodiment each of the first and second surfaces may be annular surfaces or surfaces of other complex shape with a variety of contoured and/or straight portions.

When the body 100 described herein is placed in a high temperature environment, such as, for example, being used in a kiln, the body 100 bends due to expansion and contraction during the hot and cold cycles. More specifically, the body 100 bows in a direction away from the hot face of the body 100 during the cold cycles. As a result, during the cold cycle the hot face of the body 100 becomes concave and the cold face of the body 100 becomes convex.

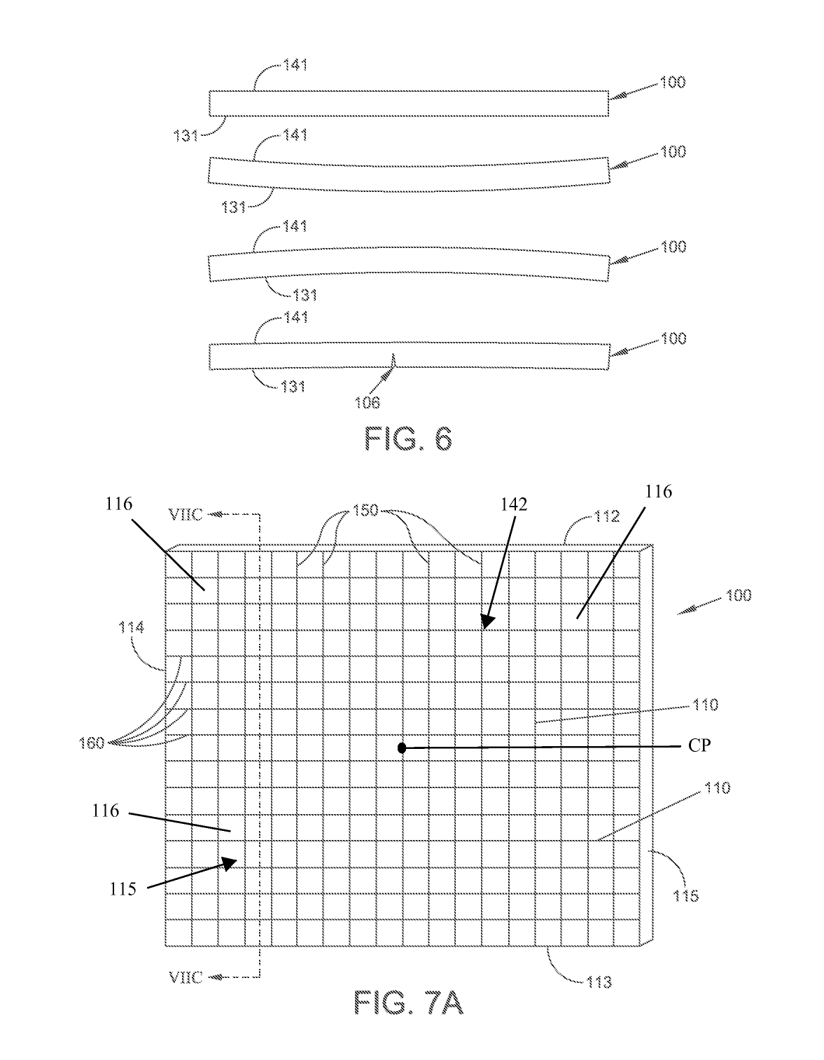

Referring to FIG. 6, an illustration is provided that shows the bending, of the body 100 that occurs during use as the kiln, furnace or other structure within which the body 100 is being used alternates between hot cycles and cold cycles. The top illustration in FIG. 6 shows the body 100 prior to being placed under high temperatures. The body 100 has a hot face 131 and a cold face 141. Before being placed under high temperatures, the body 100 maintains its structural shape such that both the hot face 131 of the body 100 and the cold face 141 of the body 100 are flat. However, as discussed above the surfaces of the body 100 are not flat in all embodiments and prior to placing the body 100 under high temperatures, the body 100 will maintain whatever shape it is formed into.

The second illustration in FIG. 6 shows the body 100 during firing, such that the body 100 is bending. During this stage, the hot face 131 of the body 100 is adjacent to or in contact with the flame, and the body 100 bends so that the hot face 131 of the body 100 becomes convex and the cold face 141 of the body becomes concave. Stated another way, during firing the hot face 105 of the body 100, which is the face of the body 100 that is adjacent the flame, expands and creates a negative deflection of the body 100. As discussed in detail above, the hot face 131 of the body 100 can be either the fill side 140 or the screen side 130, and the invention is not to be limited in that regard. Specifically, in certain applications the fill side 140 of the body 100 is positioned into contact with or adjacent the flame, and in other applications the screen 130 side of the body 100 is positioned into contact with or adjacent the flame. In certain preferable embodiments, the hot face 131 of the body 100 is the fill side 140 such that the fill side is facing towards (and in some embodiments into contact with) the flame.

The third illustration in FIG. 6 shows the body 100 during a cool cycle, such that the firing has stopped and the temperature inside the furnace or other application has decreased During the cool cycle, the hot face 131 is concave and the cold face 141 is convex. Stated another way during the cool cycle the hot face 131 contracts which creates a positive deflection in the body 100.

The bottom illustration in FIG. 6 shows the body 100 after undergoing one or more of the hot/cold cycles. More specifically, the bottom illustration in FIG. 6 shows the body 100 during one of the cool cycles. The hot face 131 is concave and contracted so that a positive deflection is created in the body 100. However, during or prior to this cool cycle the body 100 has developed a crack 106. In some applications, the crack 106 may form during the first one-hundred cycles or more. The bottom illustration shows the body 100 during a cold cycle after having, developed the crack 106. The hot face 131 of the body 100 is in a contracted state such that the body 100 is undergoing a positive deflection, but the crack 106 relieves the tension and significantly reduces the amount of deflection that occurs (as can be seen by comparing the third and fourth illustrations in FIG. 6).

Based on experimentation and testing, it is believed that the cracks form in the body 100 during the cool down part of the cycle, when the tensions are pulling, the contracting lice of the body 100. After cracking, the tensions during deflection are lessened, and are centered on the cracks. These cracks, if not prevented, reduce the life-cycle of the body 100 thereby causing the body 100 to have to be replaced. It is desirable to avoid these cracks in order to increase the life-cycle of the body 100, which can be achieved utilizing the inventive techniques disclosed herein below.

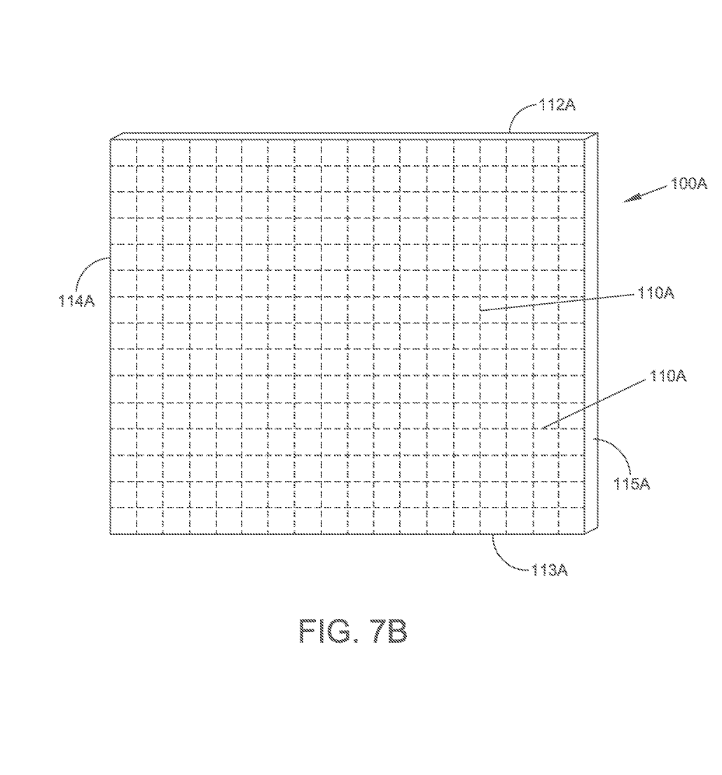

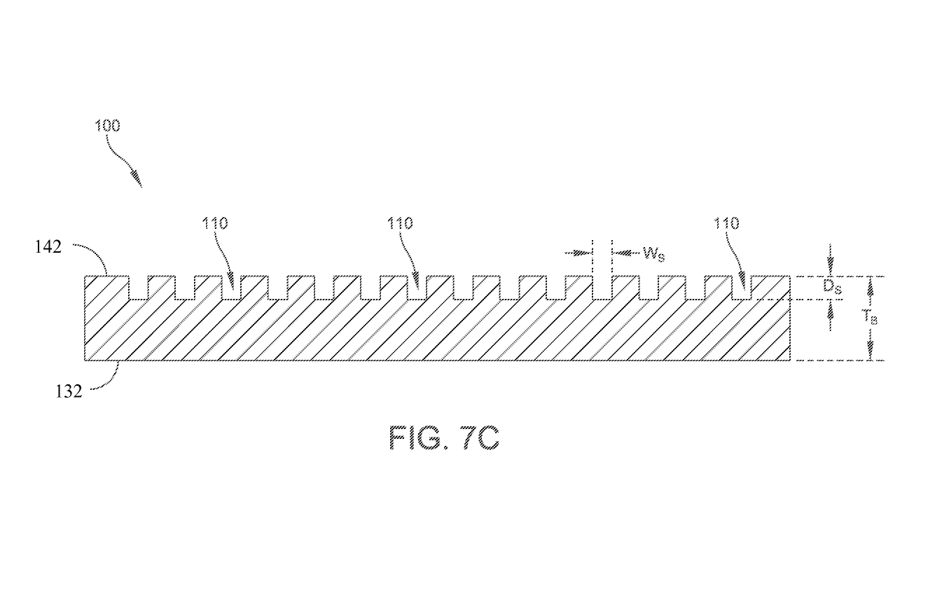

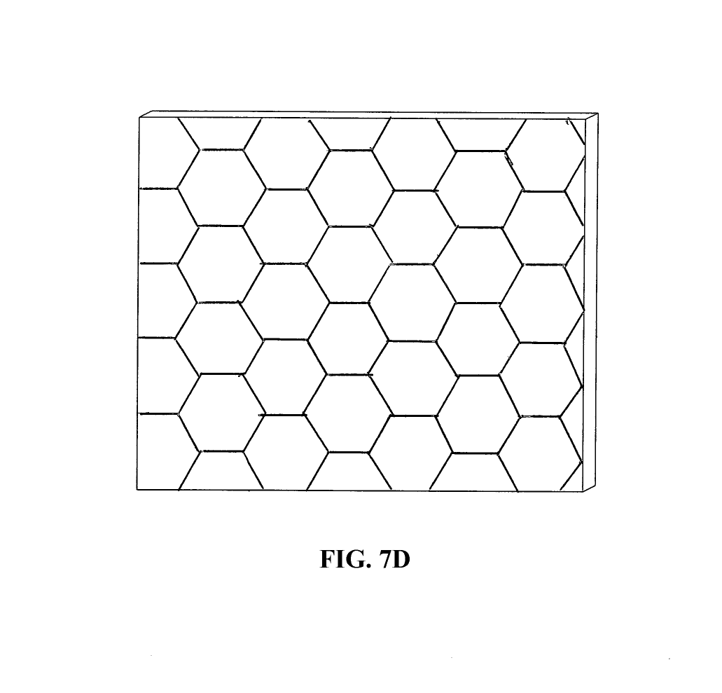

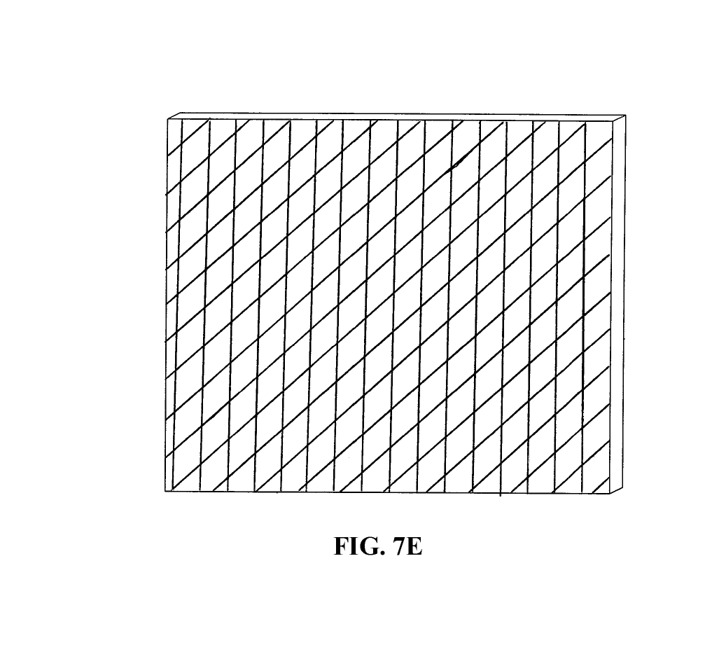

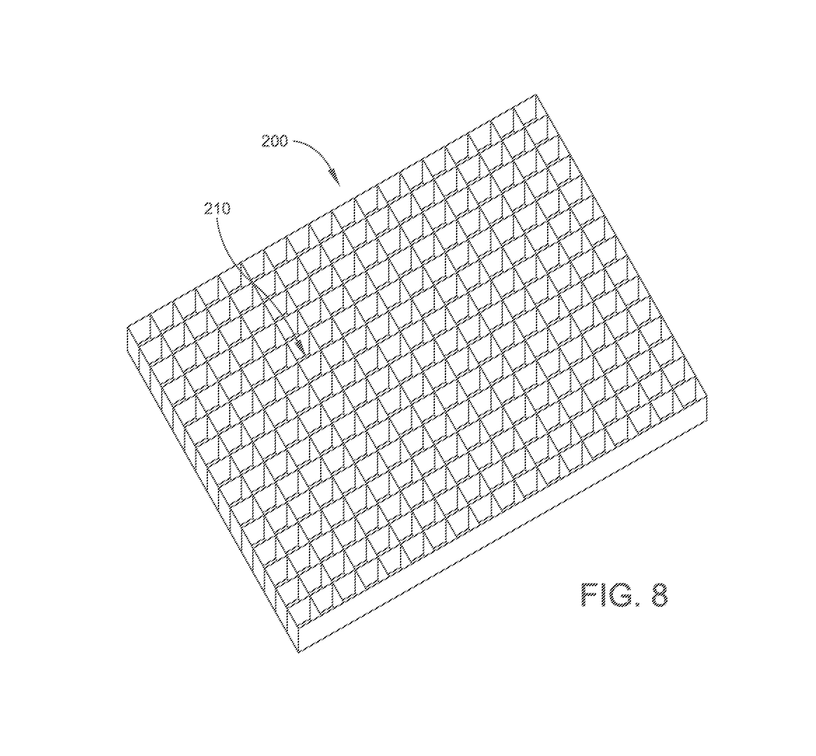

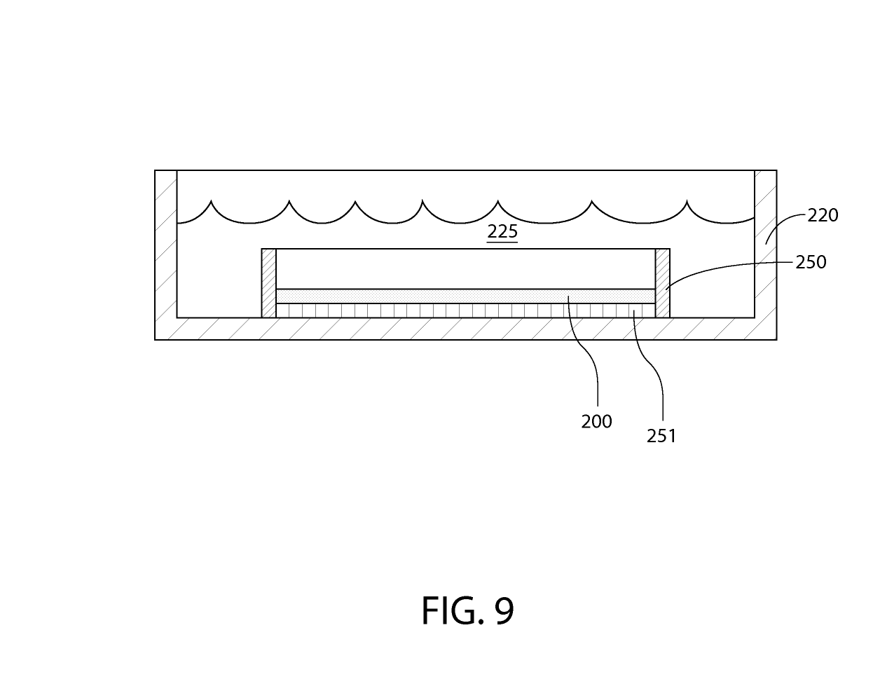

Referring now to FIGS. 7A-7C, two embodiments of the body 100, 100A having a pattern of stress relief slits 115 incorporated therein are illustrated. The embodiments exemplified in FIGS. 7A and 7B reduce or eliminate the creation of cracks on the body 100 by virtue of incorporating or forming slits 110 into the body 100. As will be discussed further below, the embodiments illustrated in FIGS. 7A-7C are riot limiting of the invention, and other embodiments and variations as will be described are also contemplated. Furthermore, various preferred methods of forming the slits 110 into the body 100 will also be described below, with particular reference to FIGS. 8 and 9.

Referring to FIGS. 7A and 7C concurrently, the body 100 that has been described herein is illustrated with a pattern of stress relief slits 115 formed into one of the surfaces of the body 100. The pattern of stress relief slits 115 comprises a plurality of slits 110. Although described herein as being formed into one of the surfaces of the body 100, in certain embodiments the pattern of stress relief slits 115 can be formed into both of the surfaces of the body 100. In the embodiment exemplified in RIGS. 7A and 7C, the pattern of stress relief slits 115 is formed into the first surface 142 of the body 100, which may be either the screen side 130 or the fill side 140, and is also the hot side. The pattern of stress relief slits 115 may also or alternatively be formed into the second surface 142 of the body 100, which may also either be the screen side 130 or the fill side 140. It has been found through experimentation that the pattern of stress relief slits 115 do not prevent crack thrmation in the body 100 when formed into the cold side of the body 100, and thus regardless of whether they are formed into the first or second surfaces 142, 132 (or the screen or fill sides 130, 140), they should be formed into the hot side i.e., the side of the body 100 intending to be used facing or in contact with the flame during use).

As used herein, the term “slit” is intended to include any depression, gouge, embossing, cut, groove, channel or score line that is formed into one of the surfaces of the body 100 to relieve tension due to thermal expansion of the body 100 during the hot and cold cycles. As discussed above, the slits 110 can be formed into the screen side or the fill side of the body 100 as desired. It is preferable that the slits 110 be formed into the side of the body 100 that is adjacent to or facing the fire or flame (i.e., the hot side) during use, although as noted above that can be either the screen side or the fill side depending on application and preference. Further still, although the invention is described herein such that the slits 110 are only formed into one side of the body 100, in still other embodiments the slits 110, 11 can be formed into both sides of the body 100.

In the exemplified embodiment, each of the slits 110 has similar dimensions. However, the invention is not to be so limited and in certain embodiments the slits 110 may have different dimensions. Specifically in certain embodiments the slits 110 can be formed using a knife by hand such that no two slits 110 will have an identical width and depth. However, in other embodiments the slits 110 can be formed using a computer numeric control machine tool, in which case each one of the slits 110 may be identical. In the exemplified embodiment, the slits 110 have an identical appearance to one another in terms of width, thickness and length.

In the exemplified embodiment the slits 110 have a width W_{S}, a depth D_{S} and a length. In the exemplified embodiment, the length of the slits 110 extends from one edge of the body 100 to another edge of the body 100. However, as will be discussed in more detail below, the slits 110 need not extend across the entirety of the surface 132, 142 of the body 100 in all embodiments. The width W_{S} of the slits 110 is preferably approximately 1/16 inch or less, and in certain embodiments is between approximately 1/16 inch and 1/32 inch, or between approximately 1/16 inch and 1/64 inch, The depth D_{S} of the slits 110 is approximately ⅜ inch or more, and more preferably between approximately ⅜ inch and ½ inch or between approximately ⅜ inch and ⅝ inch, or between approximately ⅜ inch and ¾ inch. Of course, widths and depths outside of the ranges noted above can be used for the slits 110 in other embodiments. Specifically, the width W_{S} of the slits 110 can be approximately ⅛ inch or less in some embodiments, and ¼ inch or less in other embodiments. Furthermore, the depth D_{S} of the slits 110 can be between approximately ¼ inch and ⅝ inch in some embodiments, or between approximately ⅛ inch and ¾ inch in still other embodiments. In other embodiments, the slits 110, 111 have varying depths, such as, for example without limitation, the slits in the central region of the body 100 having a greater depth than the slits in the perimeter regions of the body 100. This can be advantageous if the central region of the body 100 is subjected to greater temperatures (and temperature differentials between hot and cold cycles) than the perimeter regions of the body 100.

In certain embodiments, the thickness T_{B} of the body 100 is between approximately one inch and three inches, although in other embodiments the thickness T_{B} of the body 100 can be outside of that range (i.e., greater than three inches or less than one inch) depending on its application. The depth D_{S} of the slits 110 is designed within the ranges discussed above regardless of the thickness T_{B} of the body 100. Thus, even if the body 100 is thicker than that discussed above, the depth D_{S} of the slits 110 need not be greater than that discussed above because the range for the depth D_{S} of the slits 110 discussed above gets below the thermal expansion depth and the more rigid parts of the body 100 such that going deeper with the slits 110 does not further correct the cracking problem discussed above. In certain embodiments, a ratio of the thickness T_{B} of the body 100 to the depth D_{S} of the slits 110 is between approximately 2:1 and approximately 8:1, and more specifically between approximately 3:1 and 7:1, and still more preferably between approximately 4:1 and 6:1.

The body 100 comprises a top edge 112, a bottom edge 113, a left-side edge 114 and a right-side edge 115. In the exemplified embodiment, a plurality of the slits 110 extend from the top edge 112 to the bottom edge 113 and a plurality of the slits 110 extend from the left-side edge 114 to the right-side edge 115. However, the invention is not to be so limited in all embodiments. In certain embodiments the slits 110 may extend between adjacent edges i.e., between the top edge 112 and the right-side edge, etc.). Furthermore, in still other embodiments the slits 110 need not extend across the entirety of the first surface 142 of the body 100, but can instead be located near the center of the body 100 only and stop short of the edges of the body 100. Thus, the slits 110 in such embodiments can extend across the central region of the body 100 while being spaced apart from the edges 112, 113, 114, 115.

In the exemplified embodiment, the slits 110 comprise a first set of substantially parallel slits 150 extending from the top edge 112 of the body 100 to the bottom edge 113 of the body 100 and a second set of substantially parallel slits 160 extending, from the left-side edge 114 of the body 100 to the right-side edge 115 of the body 100. It should be appreciated that not all of the slits 110 in each set of slits is numbered to avoid clutter. In the exemplified embodiment the slits 110 of the first set of substantially parallel slits 150 are substantially perpendicular to the slits 110 of the second set of substantially parallel slits 160. Thus, in the embodiment of FIG. 7A, the slits 110 form a rectilinear grid on the first surface 142 of the body 100.

Referring still to FIGS. 7A and 7C, the grid formed on the first surface 142 of the body 100 by the slits 110 divides the first surface 142 of the body 100 into a plurality of rectangles or squares 116. Of course, the invention is not to be so limited and the slits 110 can divide the first surface 142 of the body into segments or sections of any other polygonal shape (i.e., triangles, circles, parallelograms, rhombus, diamonds, pentagons, hexagons, heptagons, octagons, etc.). This division of the first surface 142 of the body 100 into a plurality of polygonal sections is achieved by intersecting the slits 110 on the first surface 142 of the body 100 in a desired pattern. Each of the polygonal sections of the first surface 142 of the body 100 is surrounded by one or more of the slits 110.

In the exemplified embodiment, each of the rectangles 116 is a one inch by one inch square. However, the invention is not to he so limited and in other embodiments the rectangles 116 can be two inch by two inch squares. Furthermore, in certain embodiments the rectangles 116 are formed so as to have an area of approximately four square inches or less, and more specifically between approximately one square inch and four square inches. In some embodiments, the rectangles 116 can have an area of less than one square inch, and can be 0.5 inch by 0.5 inch squares, 0.5 inch by one inch rectangles, or the like. Thus, in certain embodiments it is merely desirable to form the slits 110 on the body 100 so as to divide the first surface 142 of the body 100 into rectangles 116 (or other polygons) having an area of four square inches or less.

It has been found that forming the rectangles 116 for other polygons) to have areas larger than four square inches results in some cracking on the body 100 during use over time. Thus, maintaining the rectangles 116 (or other polygons) with an area of less than four square inches is desirable. Furthermore, it should be appreciated that the smaller the size of the rectangles 116 (or other polygons), the more slits 110 that need to be formed into the first surface 142 of the body 100, which increases manufacturing costs. Thus, a combination of crack prevention and manufacturing costs can be achieved by maintaining the rectangles 116 (or other polygons) with an area of between one square inch and four square inches.

Furthermore, although in the exemplified embodiment the rectangles 116 appear to be equal in size and area, the invention is not to be so limited. In certain embodiments the rectangles 116 may have different areas. Specifically, in certain embodiments it may be desirable to form the slits 110 so that the rectangles 116 near a center point CP of the body 100 are closer together than the rectangles 116 spaced further away from the center point CP. In such embodiments, the rectangles 116 near the center point CP of the body 100 may have a larger area than the rectangles 116 spaced further away from the center point CP of the body 100 This may be desirable because the thermal stresses on the body 100 are greatest on the portions of the body 100 that are in most direct contact with the flame, which is likely to be the center of the body 100. Thus, in such embodiments adjacent slits 110 of the first set of parallel slits 150 and/or adjacent slits 110 of the second set of parallel slits 160 are spaced apart by a distance such that the distance is greater the further the slits 110 are located from the center point CP of the body 100. Stated another way, in certain embodiments the areas of the rectangles 116 can gradually increase with distance from the center point 116.

Referring briefly to FIG. 71), in certain embodiments, the pattern of slits 115 may form a honeycomb pattern on the first surface 142 of the body 100 rather than rectangles 116. In such embodiments, the pattern of slits 115 may be conceptualized as a first set of substantially parallel slits, a. second set of substantially parallel slits, and a third set of substantially parallel slits such that each of the slits of the first, second and third sets of substantially parallel slits is segmented or discontinuous.

Again, the pattern of slits 115 can take on any desired pattern and is not to be limited to funning a grid of rectangles as illustrated in FIG. 7A or to honeycomb pattern as illustrated in FIG. 7D. Referring briefly to FIG. 7E, in some embodiments it is merely desirable to have two sets of parallel slits that intersect with each other, although not necessary at ninety degree angles. Thus, the first set of substantially parallel slits may extend diagonally across the first surface 142 of the body 100 while the second set of substantially parallel slits may extend from one edge to an opposing edge (i.e., from the top edge 112 to the bottom edge 113 or from the left-side edge 114 to the right-side edge 115). Such an embodiment would divide the body 100 into a plurality of rhombus or parallelogram shaped sections.

In other embodiments, the body 100 can be divided into a plurality of triangle, circle or other shaped sections by forming the slits 110 into the body 100 in desirable configurations. Furthermore, although in the embodiments illustrated the slits 110 are all formed as straight lines across the first surface 142 of the body 110, the invention is not to be so limited in all embodiments. In certain other embodiments the slits 110 can be wavy, curved, sinusoidal or the like. In other embodiments, the slits 110 can be random such that the slits 110 are not divided into sets but rather comprise a plurality of slits 110 that intersect to divide the body 100 into a plurality of smaller polygonal sections that are separated and surrounded by the slits 110.

Although it is possible to form only one set of parallel slits into the body 100, it has been found that this does not achieve the same results as utilizing two sets of parallel slits that intersect one another, or a random array of intersecting slits. By utilizing intersecting slits, the body 100 is divided into smaller segments (i.e., the rectangles 116, or triangles, parallelograms, rhombus, circles, etc.), which are better able to handle the changes in temperature and thermal stresses. Because the body 100 is divided into smaller segments with the slits 110, the bowing of the body 100 is limited during hot and cold cycles, and cracking is prevented.

In FIG. 7A, the slits 110 are formed in a rectilinear grid having a plurality of horizontal slits extending from the left-side of the body 100 to the right-side of the body 100 and a plurality of vertical slits extending from the top of the body 100 to the bottom of the body 100. However, the invention is not to be particularly limited by the design, pattern and/or configuration of the slits 110 in all embodiments. Specifically, in certain other embodiments the slits 110 can be solely horizontal slits or solely vertical slits. In certain other embodiments, the slits 110 can be diagonal slits that extend across the body 100. The diagonal slits can all be oriented at the same angle, or can have varying angles.

Furthermore, in still other embodiments the spacing between adjacent ones of the slits 110 can be homogenous or varied. Thus, in certain embodiments the slits 110 are spaced closer together in the central region of the body 100, which is the portion of the body 110 that is subjected to the most heat, and the slits 110 are spaced further apart in the perimeter regions of the body .100, which are not subjected to as much heat as the central region of the body.

In still other embodiments, the slits 110 may not extend across the entirety of the body 100. Specifically, the slits 110 may extend from the top of the body 100 to an area adjacent the center of the body 100 and other slits 110 can extend from the bottom of the body 100 to an area adjacent the center of the body 100 without the slits extending from the top of the body 100 contacting the slits extending from the bottom of the body 100. It should thus be appreciated that although a rectilinear grid of slits is illustrated as one preferred embodiment of the present invention, many other variations of the pattern for the slits 110 can be used, including those discussed above.

Referring to FIG. 78, an embodiment of a body 100A is illustrated wherein the slits are replaced by a plurality of gouges or discontinuous slits 110A. The body 100A is the same as the body 100 from FIG. 7A except that discontinuous slits 110A are used instead of continuous slits 110. Thus, similar numbering, is used in FIG. 713 to described the body 100A as was used in FIG. 7A to described the body 100 except that the suffix “A” is being used. Certain features of the body 100A will not be described below in the interest of brevity, it being understood that the description of the body 100 of FIG. 7A above suffices.

The discontinuous slits 110A ma be considered slit segments. The discontinuous slits 110A are a plurality of small indentations made into the surface of the body 100A that are spaced apart from one another. The discontinuous slits 11A can take on any of the slit patterns as have been described herein above, such as being solely horizontal, solely vertical, diagonal, intersecting: and any combinations thereof. Thus, there are many patterns of slits, gouges and/or holes that can be used to reduce the tension seen by the face of the body 100 none of which are particularly limiting of the present invention unless specifically claimed.

In certain embodiments, it is desirable that lines drawn connecting the discontinuous slits 110A will intersect one another as has been discussed above. Thus, the pattern of the discontinuous slits 110A can be the same as any of the patterns of slits 110 discussed above, except that each of the slits is formed by a plurality of slit segments or discontinuous slits 110A. Thus, as used herein the term “slit” includes both continuous slits and non-continuous slits slits that are formed from a plurality of slit segments).

In addition to relieving, tensions caused by thermal expansion, the slits 110 also alleviate shrinkage of the body 100. When the body 100 is subjected to high temperatures, the board shrinks by approximately 3%, and more specifically between approximately 2% and approximately 5%. There is an initial shrinkage that occurs at the first fire/cool down cycle due to residual tensions in the fibers of the refractory material and the removal of hydrates that are within the body 100. Furthermore, additional shrinkage occurs during each subsequent fire/cool down cycle. The slits 110 alleviate the shrinking of the body 100 enabling better coverage by the body 100 during both the hot and cold cycles during use.

Several techniques for forming the sins 110 into the body 100 are contemplated by this invention. Specifically, the slits 110 can be formed into the body 100 during, the formation of the body 100 or after formation of the body 100. Referring to FIG. 8, a first one of the techniques for forming the slits 110 into the body 100 after formation of the body 100 will be described. FIG. 8 illustrates a die 200, such as a patterned die or a cutting die having a cutting pattern 210, which can be used to create the slits 110 after the body 100 has been tbrmed. The die 200 can be used on a die press and pressed into the body 110 to form the slits 110 therein. In the exemplified embodiment, the die 200 has a cutting pattern 210 that is in the shape of a rectilinear grid such that the die 200 can be used to form the slits 110 illustrated in FIG. 7A. The slits 110 formed will have a pattern that corresponds with the cutting pattern 210 on the die 200. Of course, the die 200 can take on any other shape and pattern so as to form any corresponding pattern of slits, including segmented/discontinuous slits, on the body 100 as has been described herein above.

In yet another embodiment, the slits can be formed into the body 100 after formation of the body 100 is completed as follows. The body 100 can be placed on a conveyer belt having rollers that come into contact with the first surface of the body 100. As the body 100 passes by the rollers, the rollers will cut, indent or otherwise form the slits 110 into the surface of the body 100. Of course, other techniques for forming the slits 110 may be used, including using a carton knife, circular knife, a saw, a computer numerical control machine tool that is properly programmed, to form the slits in a desired pattern, or the like.

Referring to FIG. 9, one technique for forming the slits 110 into the body 100 during formation of the body 100 is illustrated. Specifically, FIG. 9 illustrates a tank 220 that is filled with an aqueous slurry 225, such as the slurry 25 described herein above with reference to FIGS. 1-5. A mold 250 and a die screen 251 are placed within the slurry 225 in the bottom of the tank 220. Furthermore, the die 200 described above with reference to FIG. 8 (or a similar die) is positioned within the tank 220 so as to be adjacent to the the screen 251 within the mold 250. Utilizing this technique, the vacuum process will achieve formation of the body 100 within the mold 250, and the die 200 will create indentations (i.e., the slits) into the body 100 during the formation of the body 100. Although this embodiment is exemplified with the die 200 on the screen side 230 during formation of the body 100, in other embodiments the die 200 can be positioned adjacent the fill side 240 of the body 100 to form the slits into the fill side 240.

Using the technique of FIG. 9, the stress relief slits are formed into the body 100 during the dehydrating step discussed above with reference to FIGS. 1-5, Thus, as the aqueous slurry 225 is hardening to form the body 100 due to the vacuum pressure being applied, the body 100 will harden around the cutting pattern of the die 200 so that slits correspondine to the cutting pattern of the die 200 are formed directly into the desired surface of the body 100. This can be advantageous by negating the need for a separate step for forming the slits because the slits are automatically formed into the body 100 during the body formation process steps.

Although described herein with regard to a body 100 formed of a refractory material during a vacuum forming process, the techniques described herein can be used for other refractory materials to prevent or lessen cracks that occur due to thermal stresses. For example, the inventive techniques described herein can be useful for hard ceramic bodies in addition to those described herein. Any rigid body that is used as a refractory material and subjected to significant temperature differentials can benefit from the teachings and techniques disclosed herein.

### Experiments

The invention can be better understood and more fully appreciated from the experiments that were performed using the inventive body having slits formed therein. The experimental data is more fully described herein below.

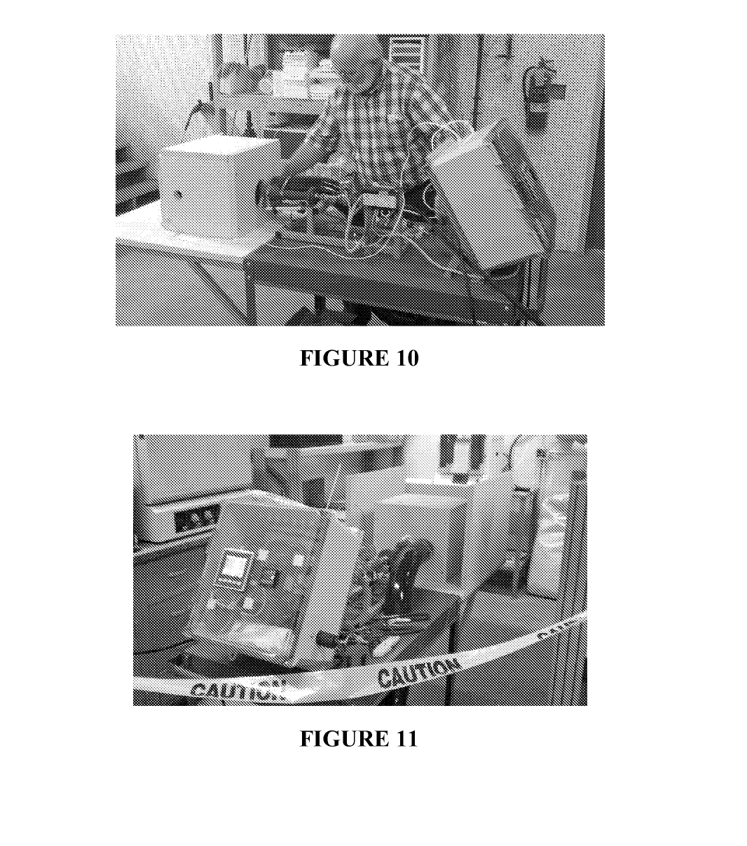

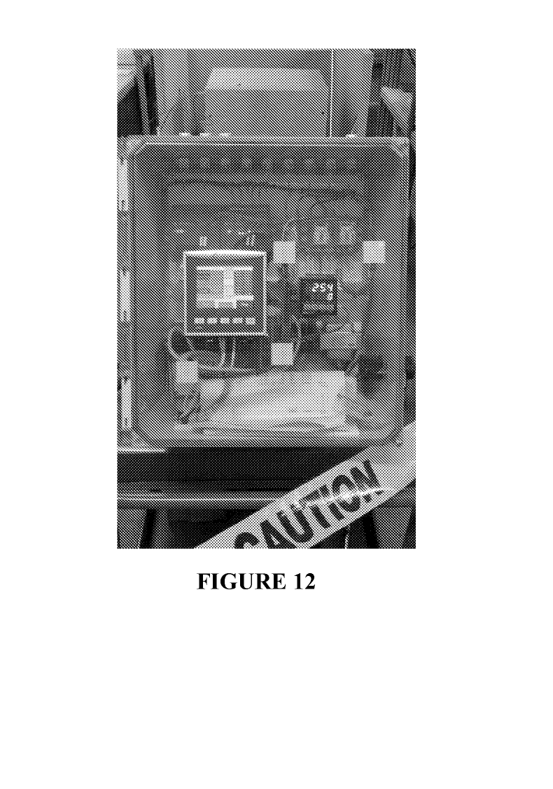

Bodies having slits (i.e., depressions, gouges, embosses, cuts or score lines) formed therein were tested to determine whether they reduced cracking in the bodies. Test equipment was designed to subject insulation panels to repeated heat and cool cycles utilizing a gas burner designed for small kilns. An insulation box of 2″ material was built with a hole for the gas burner in one end and the other end open. A PLC program was written to specify a maximum and minimum temperature that the insulation panels would be subjected to and the time to remain at each specified temperature. Everything was placed on a convenient mobile stand. Finally an exhaust hood was added to keep the carbon monoxide levels down during the long tests. FIGS. 10-12 illustrate the test equipment that was built and used in the experiments described herein below.

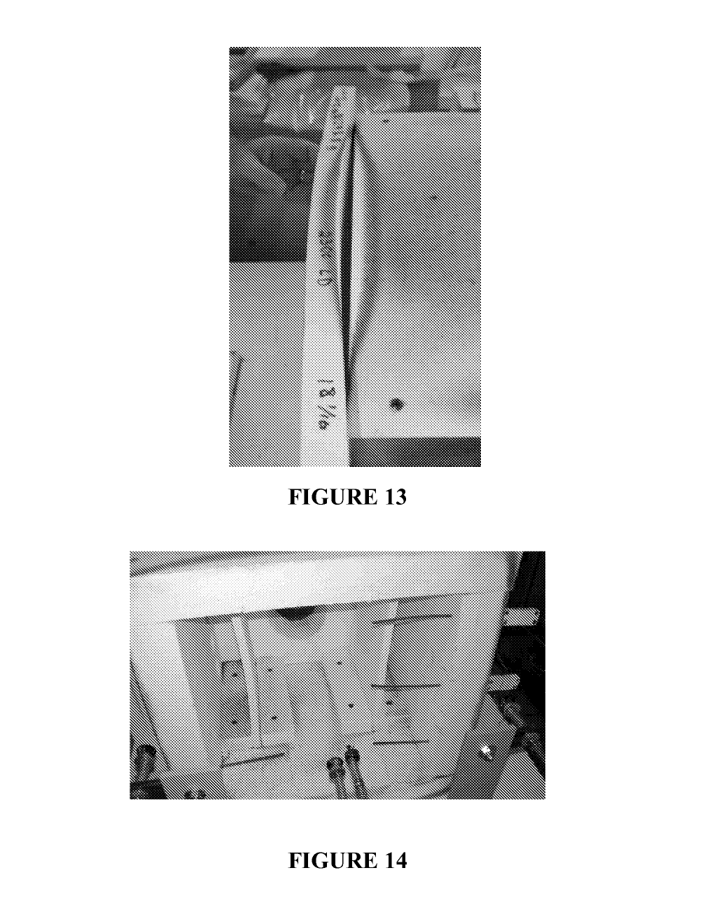

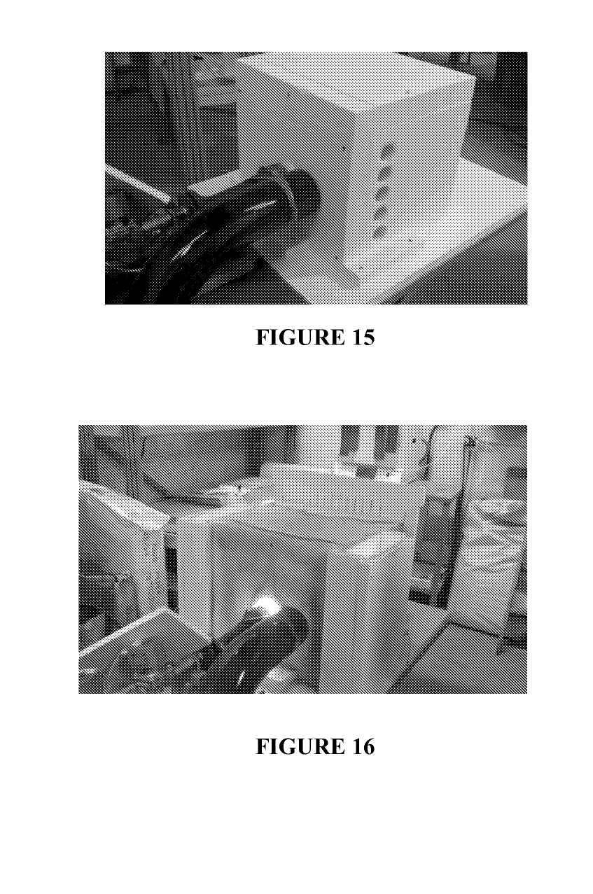

In the first trial with a 1″ thick sample board in place it was noticed that the hoard was visibly bowing away from the hot face even more than expected (see FIG. 13). It was determined that the amount of deflection may be a direct measure of the tension. The sample is held in place with spring loaded metal pads mounted to a bracket that is bolted down to the floor of the unit to insure a stable mount for the transducer. Temperatures are monitored at the bottom, center and top of the hot face of the sample, and in the center of the cold face of the sample. The ambient temperature is also recorded. FIG. 14 shows the location of the thermocouples. Also visible are the interior baffles used to increase the length of the flame path to the exhaust. This is done in awareness of the time required at the current flame speed to consume the gas completely and avoid flame exiting the exhaust. FIG. 15 illustrates the unit fully assembled lust prior to operation.

FIG. 16 shows the unit in operation with a Raypak 717 board installed as the sample being tested. The large black pipe is used to direct ambient air into the box during the cooling cycle. This helps maximize thermal stress on the board, and shortens the cycle time. Boxes were placed over the exhaust ports to create “chimneys” for efficiency and safety. The area of the sample being exposed to heat is 12″×12″. The test rig allows the sample to be larger than the heated area at the sides and top. This maximizes the stress on the hoard by allowing a “frame” of the sample that does not see the heat, and so does not expand and contract during the cycles. It was believed that it might take 100 or more cycles to see cracking develop, so this “rigid frame” of material was created to help insure the board develops cracks more quickly. It was desired to see what happens to a board that is fully supported by the OEM's steel box. The question was if the board is not allowed to deflect will it still develop arty cracks, and if so, how will they he different than an unsupported board. A frame made from steel was built to hold the board as securely as possible, and prevent the deflection we see in a board that is only held against the opening of the heat box.

### Test 1: 2300 HD 1″ Thick, 2100° F., No Relief

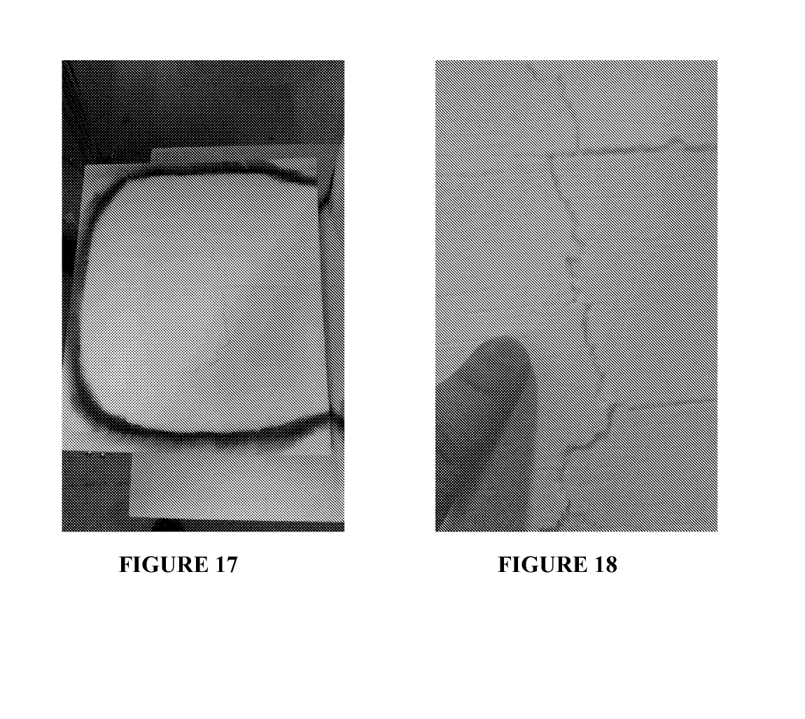

Referring first to FIGS. 17 and 18, the board of the first test is illustrated after testing. In the first test, the TSS was set to rise to 2100° F. and hold for 3 minutes, then fall to 150° F. and hold for 3 minutes, and repeat for 100 cycles, The sample was a 1″ thick 2300 HD board, 15″ wide and 18″ long. The prominent dark ring seen in FIG. 17 is the area where the starch (i.e., organic binder) has burned, but not burned off. Within the ring is the white center where the heat was sufficient to burn off the starch. Outside the ring the board still retains its original starch content. The back side of the board is very dark, indicating, that the starch has burned, but some portion still remains. The outside dimensions did not change enough to measure it with a tape ruler and we have not considered the outside dimension change significant to employ calipers.

The crack pattern we see in Test 1, best seen in FIG. 18, is very similar to that which has been seen in live, rather than experimental, conditions. The cracks are most pronounced in the center of the heated area, becoming fewer in number, farther apart, and less deep as they approach the border between the heated and unheated area. The severity of the cracking forms a pattern that is consistent with a set of rings that move from rectangular at the outside of the board to a point in the center of the heated area. This pattern appears to be a result of the central heat location and the geometry of the heated area combined with the board shape.

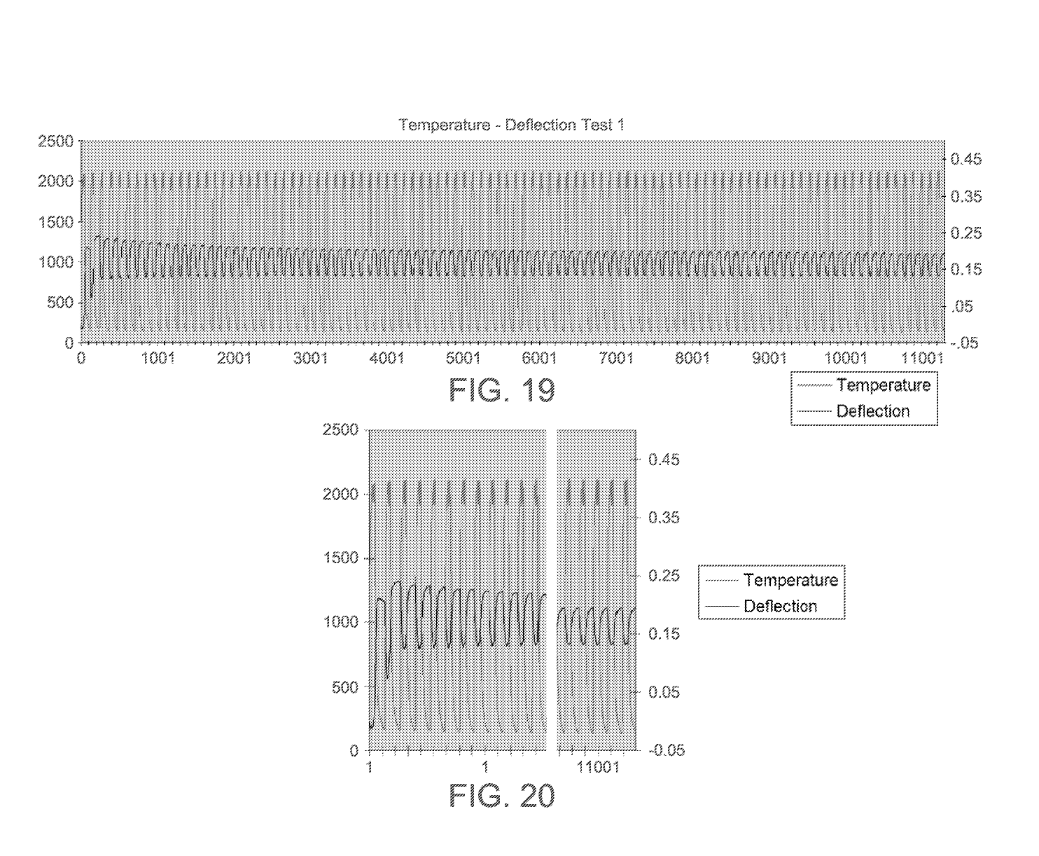

Two metrics were created to measure, including a “Number of Visible Cracks” which can be 0, 5, 10, 25, 50 or 100, and a “Depth of Visible Cracks” which can be from 0 to the thickness of the board in 1/16″ increments. As mentioned, five temperatures were recorded and the deflection of the cold face center of the sample. The charts in FIGS. 19 and 20 shows the hot face temperature on the scale on the left and the deflection on the scale to the right.

FIG. 20 shows a close up of the beginning and end of the cycle. The deflection is set to 0.0 before the first cycle. As the first cycle begins we see the minimum deflection occur (−0.013″). The maximum deflection occurs (0.241″) during the second cycle. The minimum deflection moves up to about 0.132″ and stays there for the remainder of the test. The maximum deflection continues to decrease, ending at 0.194.″ It is still getting smaller, but very slowly. The range of deflection on Test 1 was 0.254″. The bottom scale shows the time in 10's of seconds, so 1001=10010 seconds, or 166.83 minutes. The duration of the entire 100 cycles of Test 1 shown is 31.37 hours.

### Test 4: 2300 HD 1″ Thick 2100° F. 100 Cycle: Relief: 1″×1″ Grid 0.25″ Deep

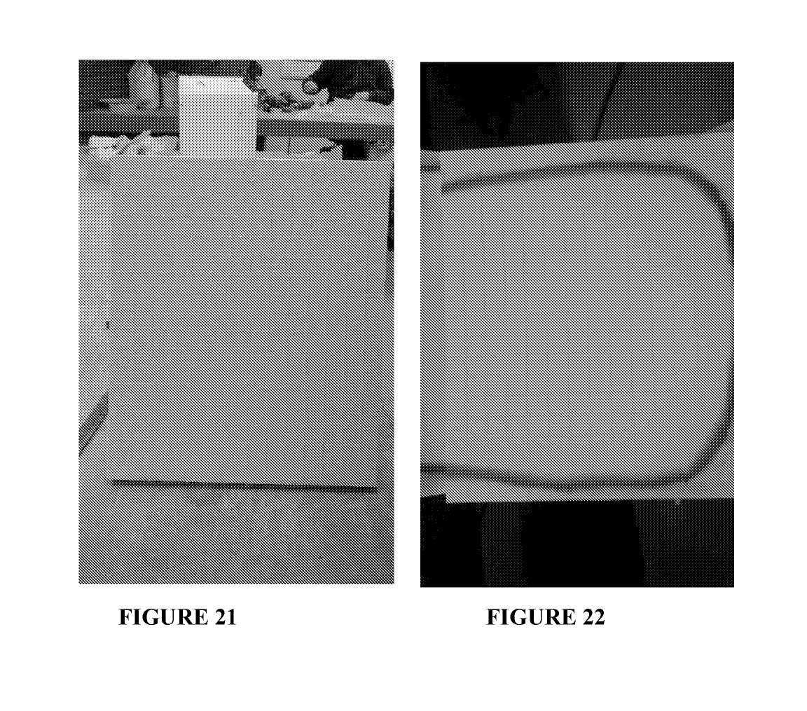

Referring to FIGS. 21 and 22, next we tested the first board that incorporated a relief pattern to test our theory. Using a knife we cut a series of ½″ deep slits into the hot face of the sample forming, a 1″×1″ grid. Other than this modification the board was identical to that used in Test 1.

FIG. 21 illustrates the unfired board with the relief pattern. FIG. 22 illustrates the board after firing. There are no visible cracks. Our first relief pattern test shows us that the grid of slits we cut into the board helped prevent the formation of thermal shock related cracks, and for practical purposes may have eliminated them completely.

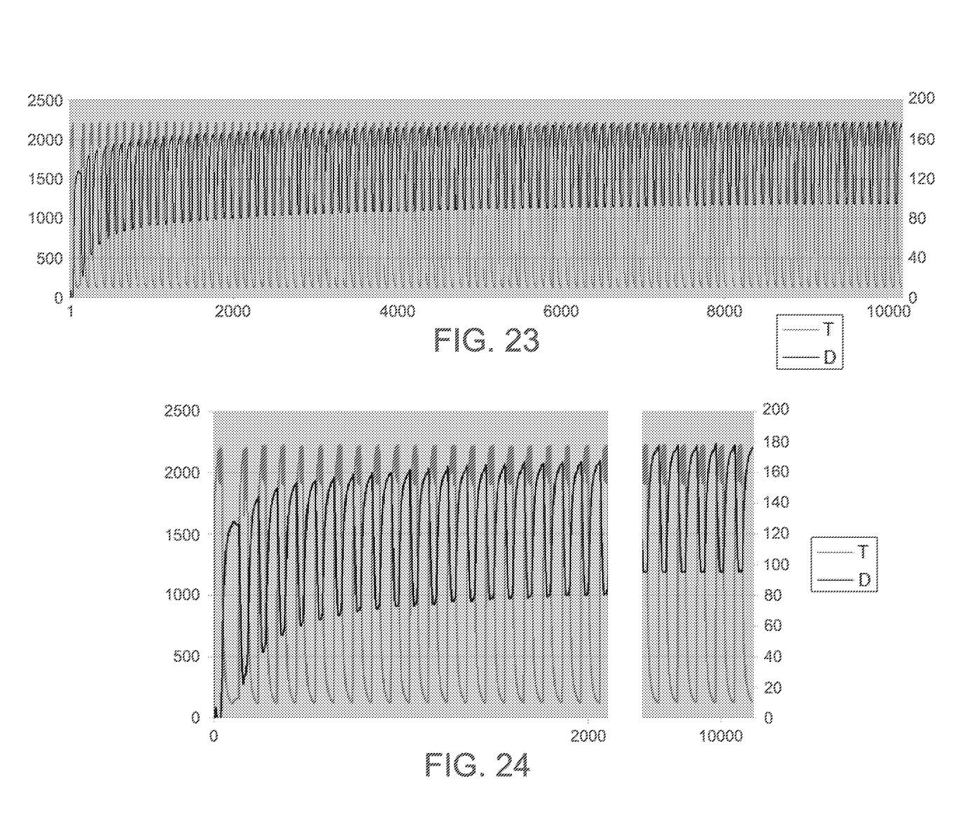

FIG. 23 illustrates the dual scale chart for Test 4, again with the temperature on the scale on the left and the deflection on the scale to the right. If you compare this data to that of Test 1, the differences in deflection are interesting. In both tests the deflection is set to 0,0 before the first cycle. As the first cycle begins we saw the minimum deflection of Test 1 at −0.013″ compared with −0.022″ in Test 4. In both tests the minimum deflection occurs as the first cycle begins. The maximum deflection of Test 1 was 0.241″ during the second cycle. The Maximum deflection of Test 4 is 0.179″ and occurs near the end of the test. The minimum deflection of Test 1 moved up to about 0.132″ early in the test and stayed there for the remainder of the test. The minimum deflection in Test 4 also moves up, but continues to move up (get larger) throughout the test.

In Test 1 the maximum deflection continued to decrease, ending at 0.194″ and still getting smaller. In Test 4 the maximum deflection gets larger for about 50 cycles, then begins to level off around 0.179″. The range of deflection on Test 1 was 0.254″. The range of deflection on Test 4 is 0.201″.

FIG. 24 is a close up that shows the difference in behavior of the deflection for Test 4. This difference may be telling us that the smaller Overall deflection seen in Test 1 is due to the cracks. As the cracks form they relieve the stress from thermal expansion and contraction, lessening, the board deflection. In Test 4 the grid pattern has relieved the stresses enough that they are not creating visible cracks (at least not in the duration of the test) and so the deflection remains at a higher level. It is interesting to see that the minimum deflections (during the cold part of the cycle) continue to increase. Perhaps the tensions being created by the expansion and contraction are finding a new balance, resulting: in a “permanent” deflection.

The final range of deflection is difference between the unrelieved board and the relieved board. The difference between the max and min deflections during the last hour of Test 1 is 0.063″ (0.194 to 0.131), while during the same period of Test 4 it is 0.084″ (0.179 to 0.095). This supports the idea that there is tension remaining in the board that incorporates the grid and does not show the cracking. It may also suggest that the cracking evident in Test 1 is not complete, and that the cracks would have become larger if we had extended the test. By the same logic the fact that the range of deflection in Test 4 is continuing to get smaller, we can assume that these tensions are decreasing. This indicates that some cracking is occurring in the sample. The fact that we cannot see it probably means that it is occurring along the slits, in other words the data may be telling us that although it is difficult to see, the slits in Test 4 are most likely becoming deeper during testing.

### Test 8 and 9: 2300 LD 1″ Thick, 2100° F. Test 9 has No Relief, Test 8 has 1″×1″ Grid 7/16″ Deep Slits

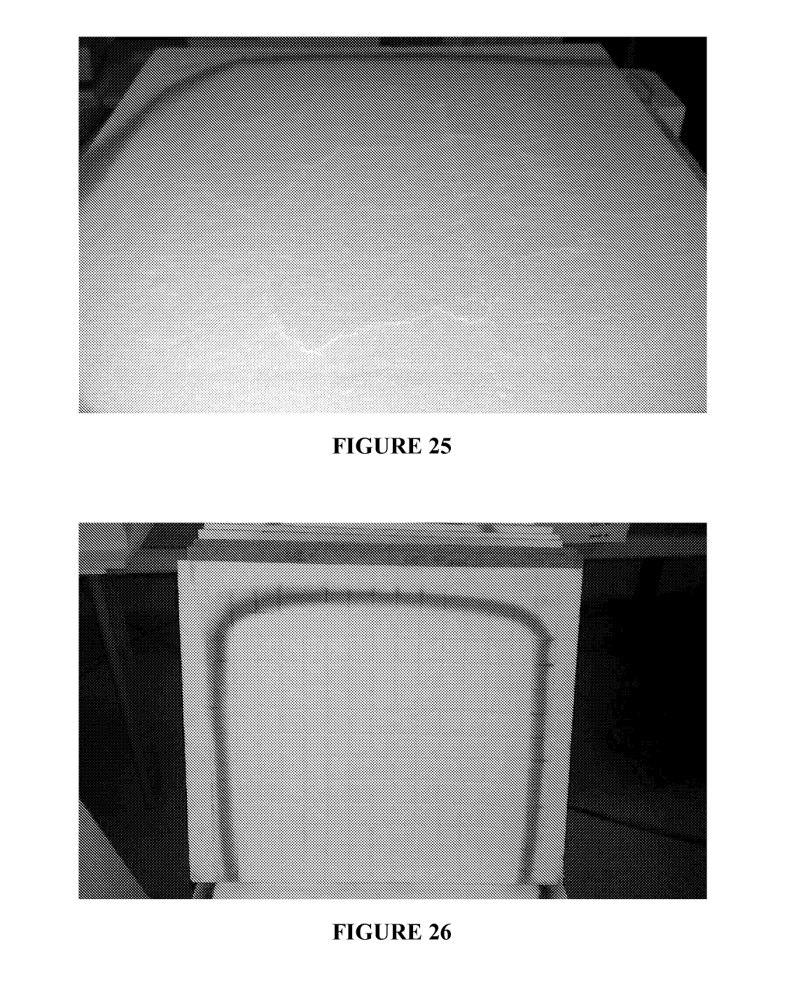

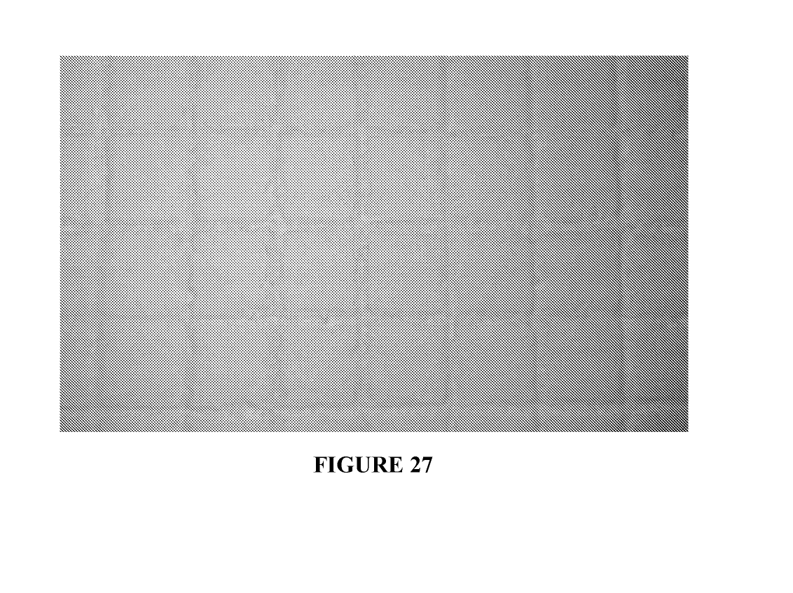

The samples for Test 8 and 9 were cut from the same board to insure as much as possible the same composition and density. The difference between the two samples was limited to one with a relief pattern (Test 8 and one without (Test 9). FIG. 25 illustrates the board of Test 9 without a relief pattern after being subjected to testing. FIG. 26 illustrates the board of Test 8 with a relief pattern after testing. Test 9 showed visible cracks which we rated as 10 cracks 1/4″ deep. FIG. 27 illustrates a close-up of the board of Test 8 after being, subjected to testing. The board of Test 8 showed no visible cracks after testing.

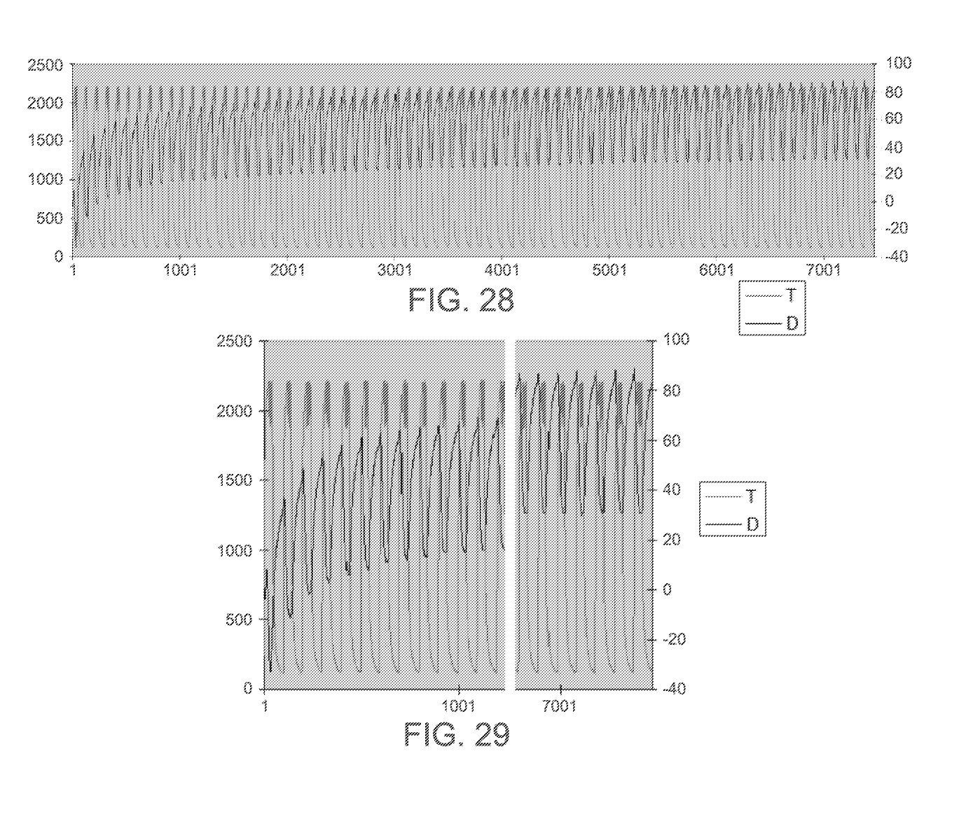

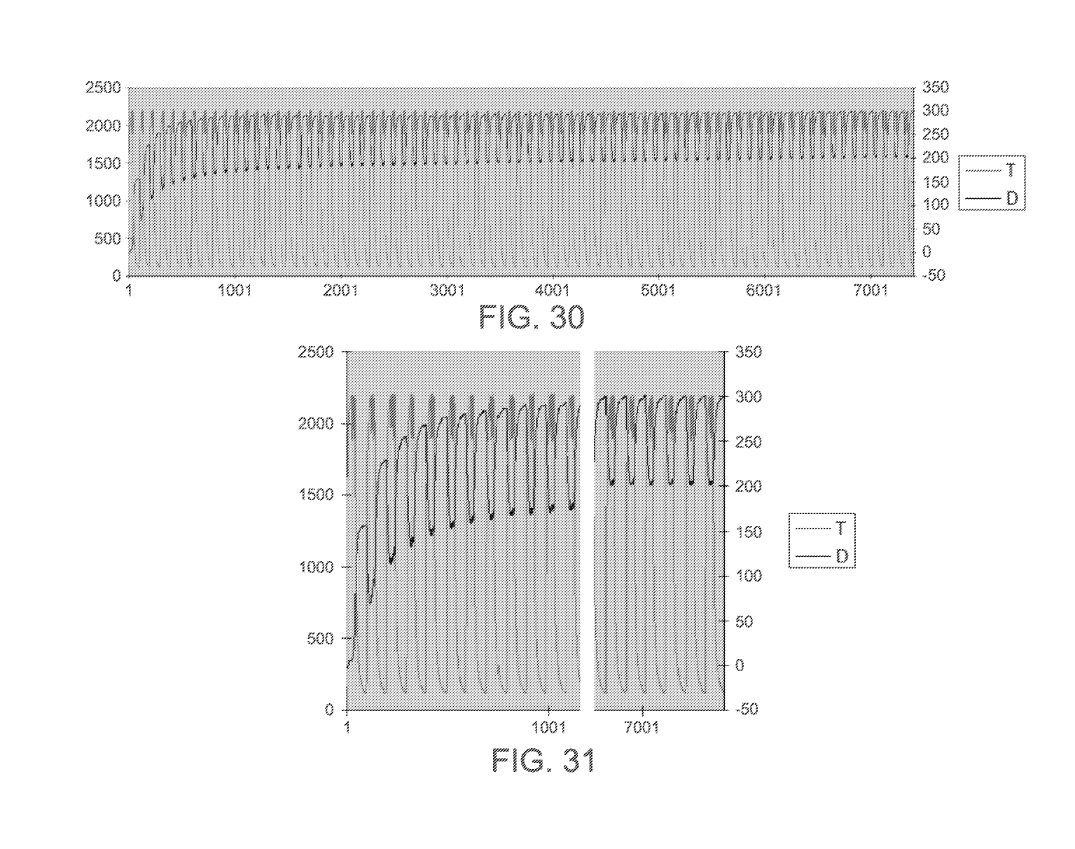

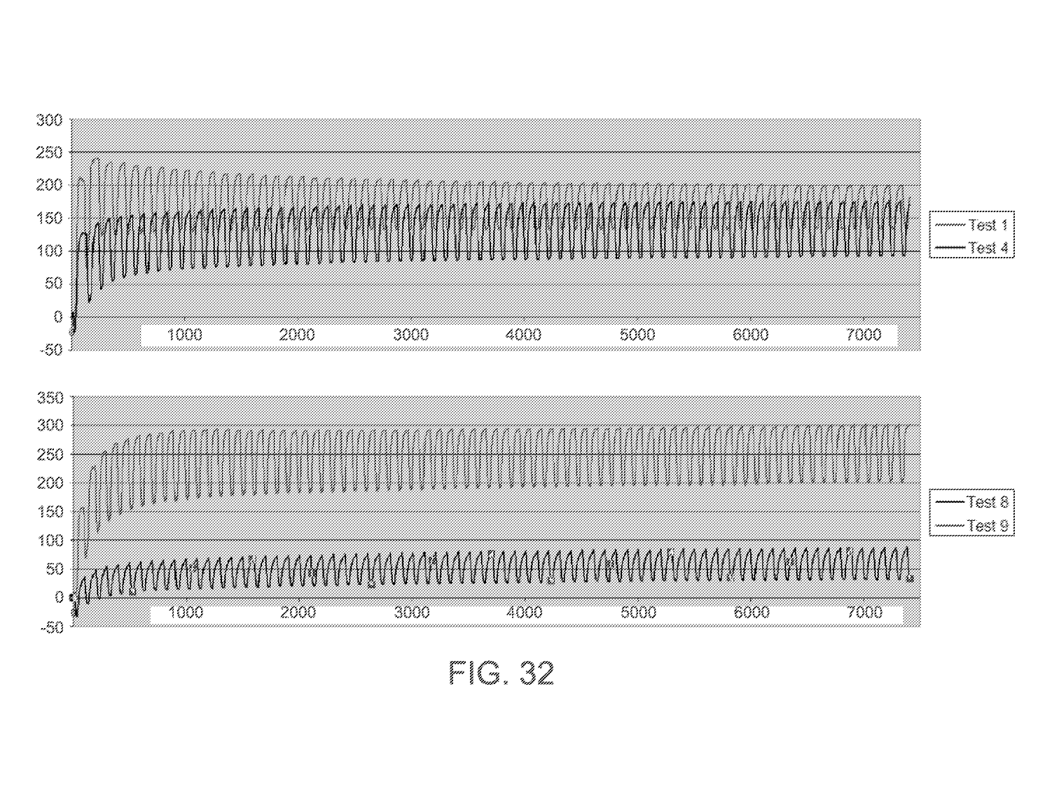

FIGS. 28 and 29 are charts illustrating, the results from Test 8, and FIGS. 30 and 31 are charts illustrating the results from Test 9, Please note that the deflection scale is different on the two charts when comparing. Notice that the deflection ranges at the end of the tests are different. During the last hour, Test 8 (with slits) ranges from about 0.088″ to 0.032″ while Test 9 (without slits) ranges from about 0.300″ to 0.200″. Since the scales for deflection on the above charts are different, it may be easier to compare them if we see the deflection data at the same scale. FIG. 32 provides two charts that shows the relative amounts of deflection with a little more clarity.

FIG. 28 shows Test 1 (cracks) in red and Test 4 (relieved) in black. FIG. 30 shows Test 9 (cracks) in red and Test 8 (relieved) in black. FIG. 28 samples are 2300 HD and FIG. 30 are 2300 LD, Notice that the largest deflection (highest tension) occurs during the cooling part of the cycle, and that the deflection lessens (lowest tension) during. the heating part of the cycle. It seems that the amount of deflection is dependent on the amount of tension created by the change in dimension of the hot face. The fact that the center point, of the range of deflection is higher for Test 1 than for Test 4 seems at first glance to be counter to the fact that Test 1 has visible cracks and Test 4 does not. Indeed, the data from the second set is even less what might be expected. However, it should be appreciated that Test 4 and Test 9 do indeed have cracks, but they were placed there in the form of man-made slits rather than cracks that result from testing. The slits are relieving. enough of the tension to prevent the board from deflecting to the extreme that it did before the “natural” cracking occurred.

### Test 14: 2300 LD 1″ Thick, 2100° F. 75 Cycles, Relief: 1″×1″ Gouge Pattern 5/16″ Deep

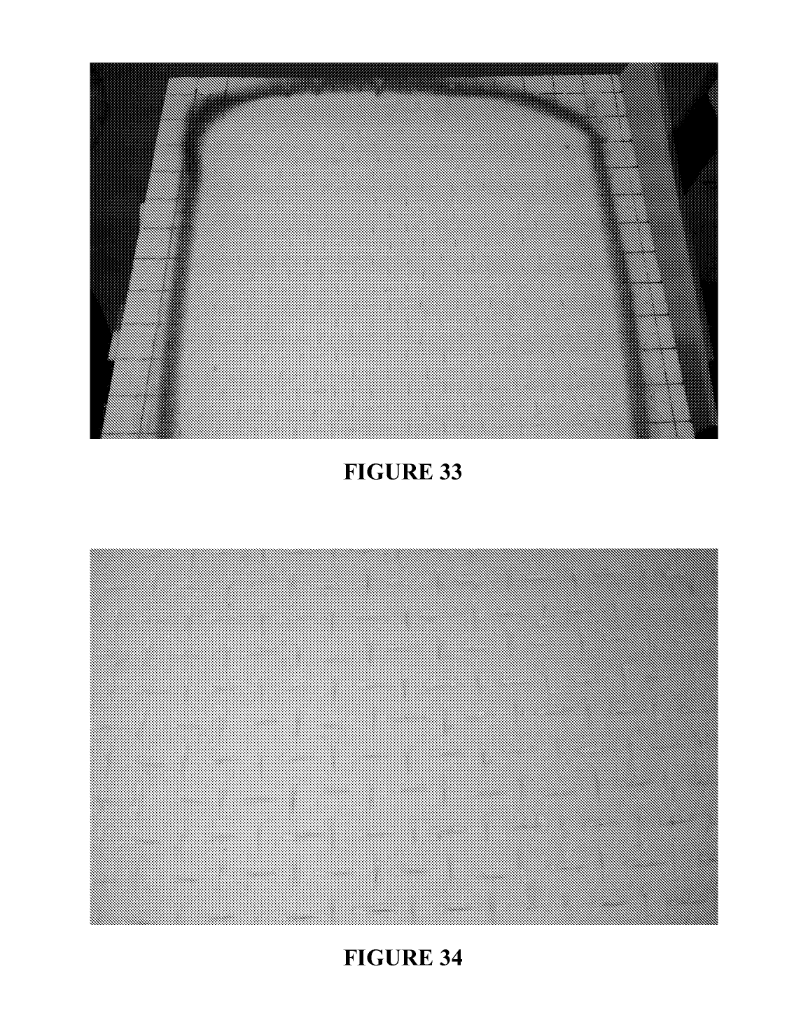

We tested a board that incorporated a relief pattern that consisted of discontinuous gouges. We used the same carton knife used to make the slits, but we just pushed the blade into the board every inch along the grid pattern lines. FIGS. 33 and 34 illustrate the board from Test 14 after testing. These Figures illustrate that in Test 14 after 75 samples, there is still no evidence of cracking. Based on these results, it can be concluded that this discontinuous relief pattern prevents cracking.

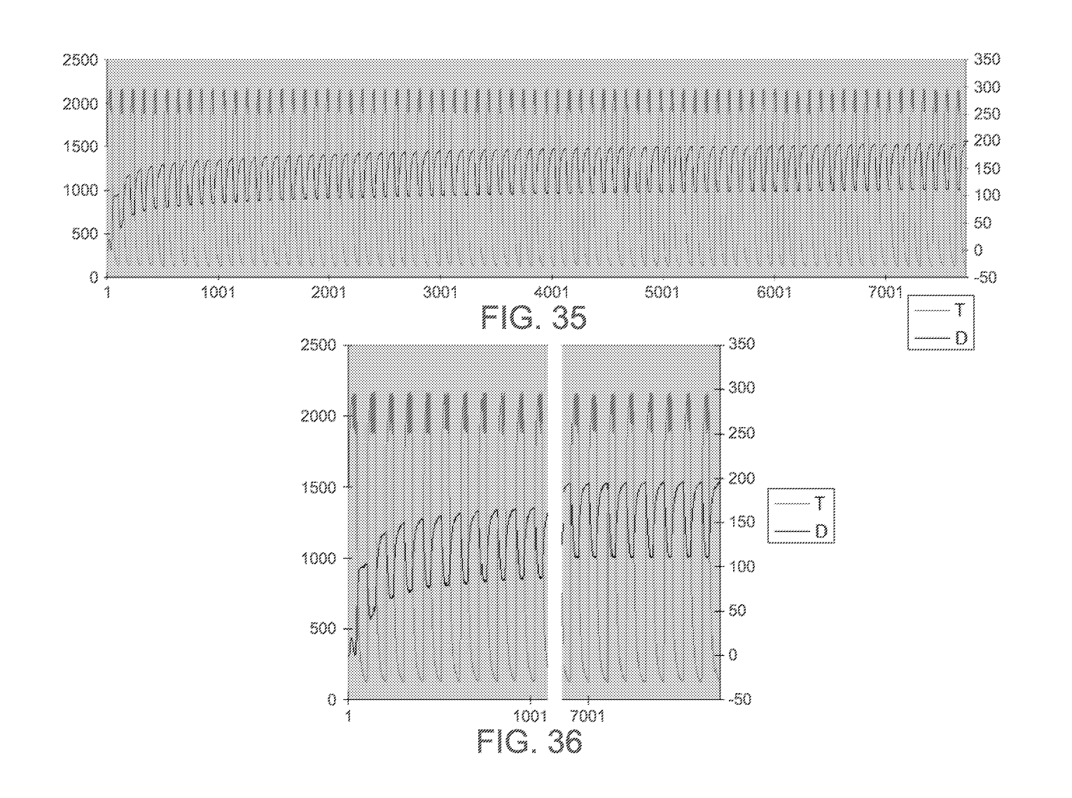

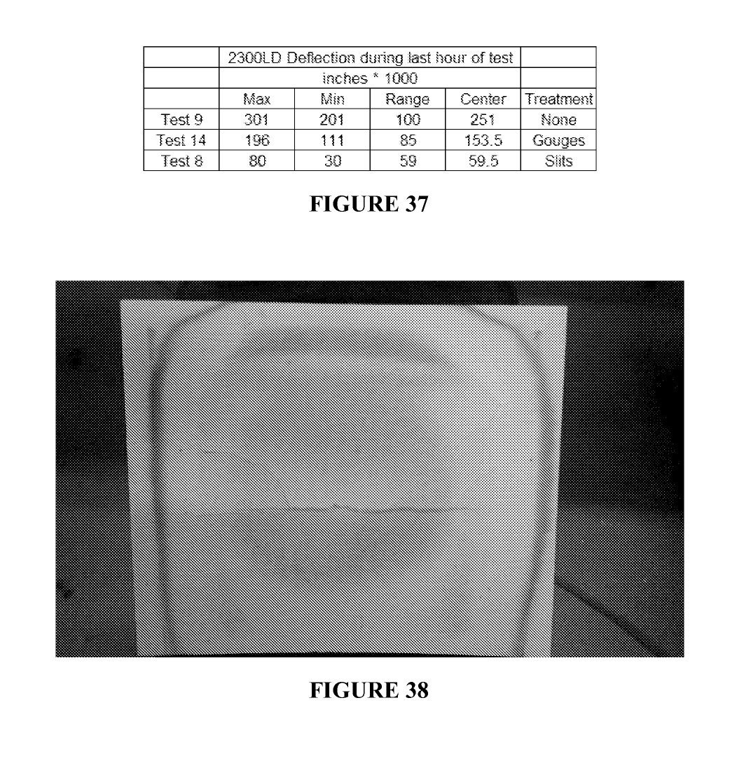

FIGS. 35 and 36 chart the results from Test 14. The scale for deflection has been set to match FIG. 32 so it is easy to compare with Test 8 and 9. The center of the deflection range at the end of the test lies between that of Test 8 and Test 9. The table in FIG. 37 shows the results of measuring deflections for these three tests to make it easy to see this connection.

### Test 20: 2300 LD Rigidized 1″ Thick, 2100° F.

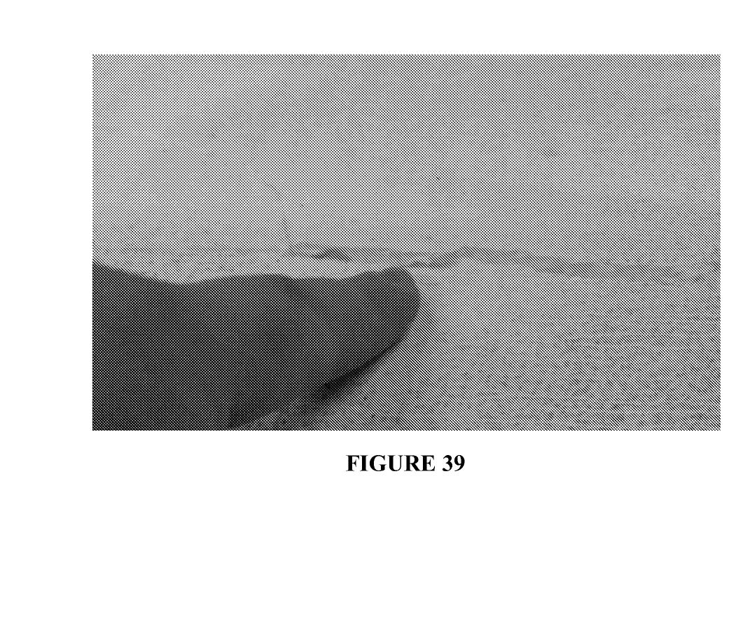

Test 20 was completed to have a rigidized sample of 2300 LD to compare with a non-rigidized sample of 2300 LD, FIG. 38 illustrates the rigidized 2300 LD after testing, and FIG. 39 illustrates a close-up of the rigidized 2300 LD after testing. Using the 2300 LD, the cracking is audible during the first cool down.

FIGS. 40 and 41 illustrate the deflection data for Test 20, rigidized 2300 LD. It is interesting to compare with FIG. 30, the data for Test 9, which is a non-rigidized 2300 LD. The two sets of data have very similar range of deflection at the end of the test The most obvious difference is only that the rigidized sample takes more cycles to reach its full deflection.

Another interesting feature of the deflection data for Test 20 is the filet that the maximum deflection (cool cycle) for cycle 3 is about the same as cycle 2, when we would have expected it to be a little larger. A second feature of note occurs at max deflection at cool cycle 37 where there is a decrease in the amount of deflection compared with the previous cycle. This may indicate that the tension has been released in a dramatic manner. In other words, a large crack may have developed very quickly at this point. During testing, we have occasionally heard an audible, and sometimes loud “pop” come from the boards, especially during the first cool down.

Test 21 and 22: 2300 LD Rigidized 1″ thick, 2100° F. In Frame

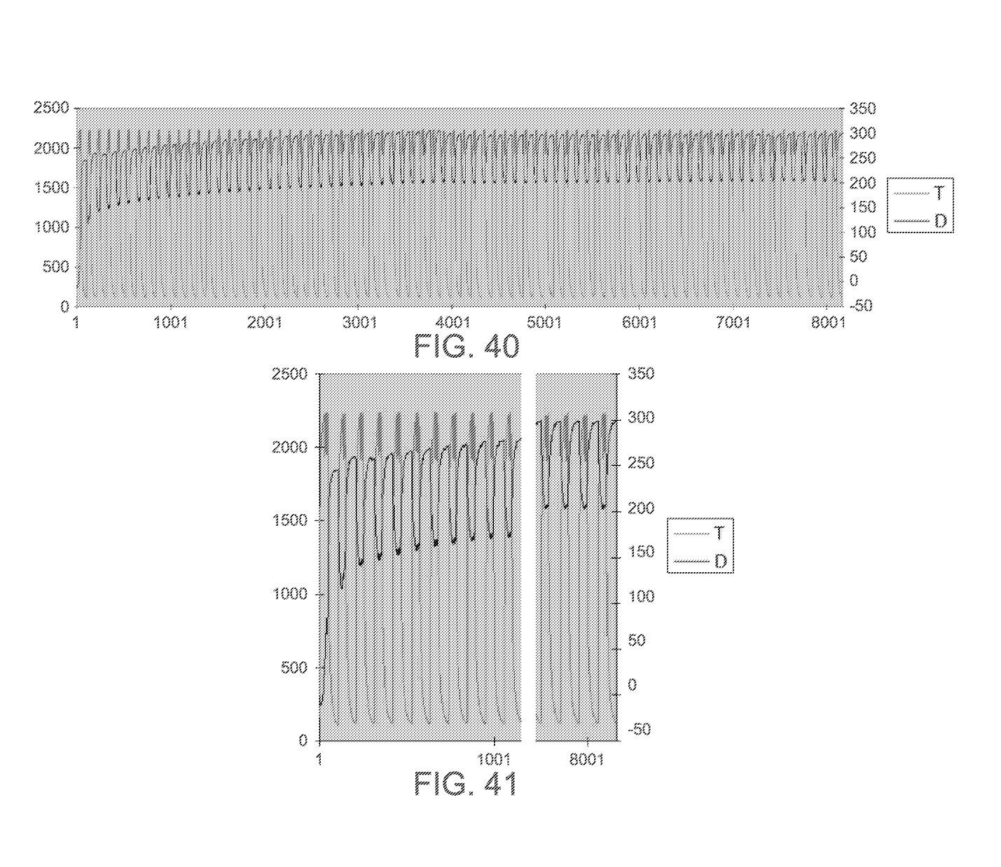

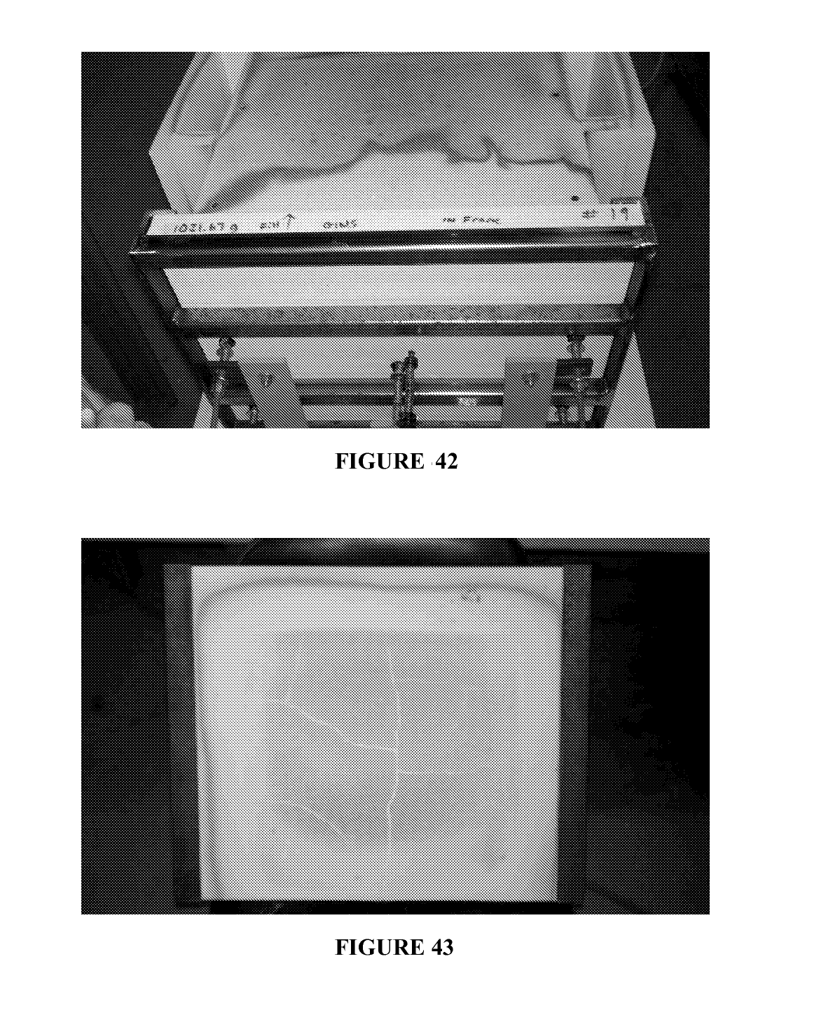

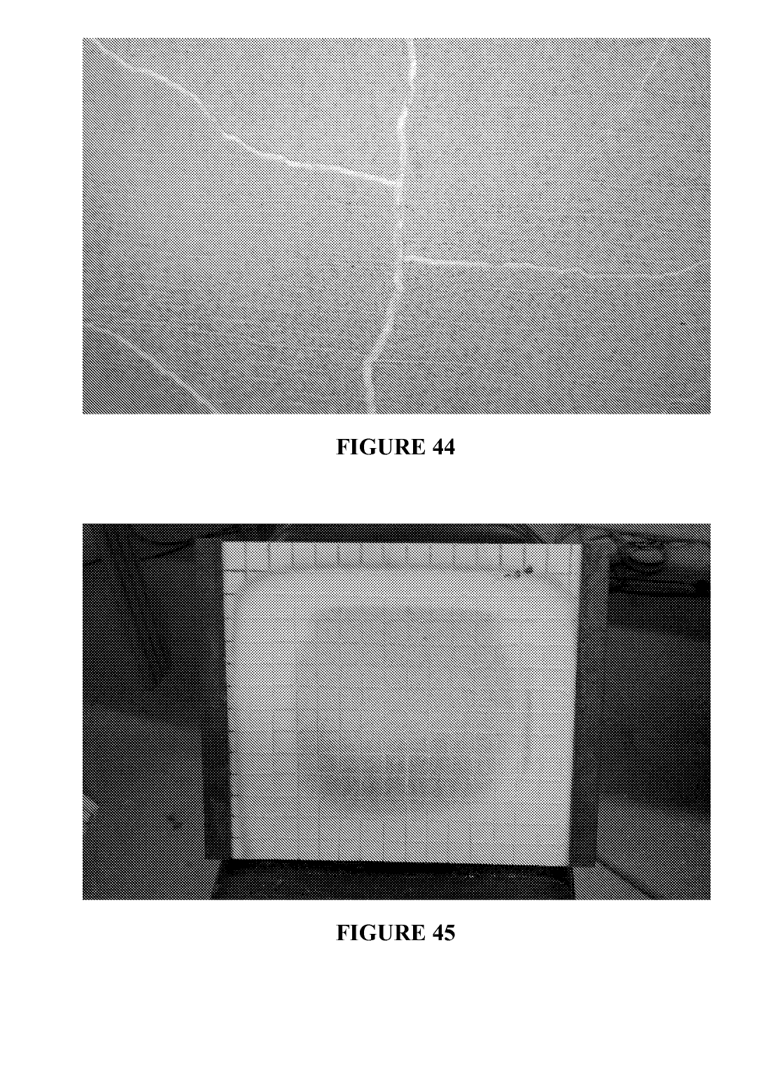

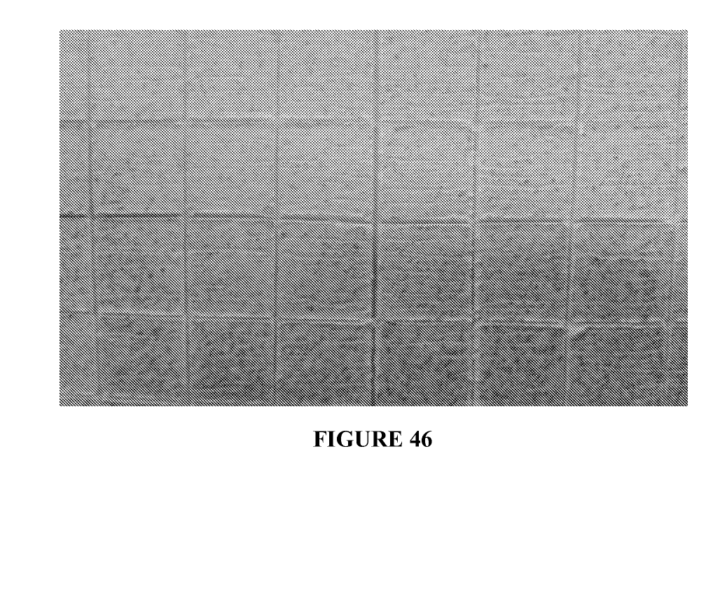

This set of tests was done to see what the impact on cracking would be if we put the sample in a steel frame to prevent as much deflection as possible. For Test 21, the rigidized 2300 LD sample was placed in a steel frame to prevent as much deflection as possible. The sample is almost completely unable to move during testing (see FIG. 42). The cracking of the fully supported (restrained board) is easily visible in FIGS. 43 and 44, This is illustrated in FIG. 42. FIGS. 45 and 46 illustrate this same board with slits. A couple of the slits are wider than the rest after testing, indicating that some additional cracking occurred along the slit line. These results exemplify that restraining the board in a steel cabinet, as is common practice by the OEM, do not help prevent cracking and may in fact make it worse.

Test 26 and 27: C-Cast Ritidized 1″ thick, 2100° F. Test 26 has no relief. Test 27 has 1″×1″ grid 5/16″ Deep Slits

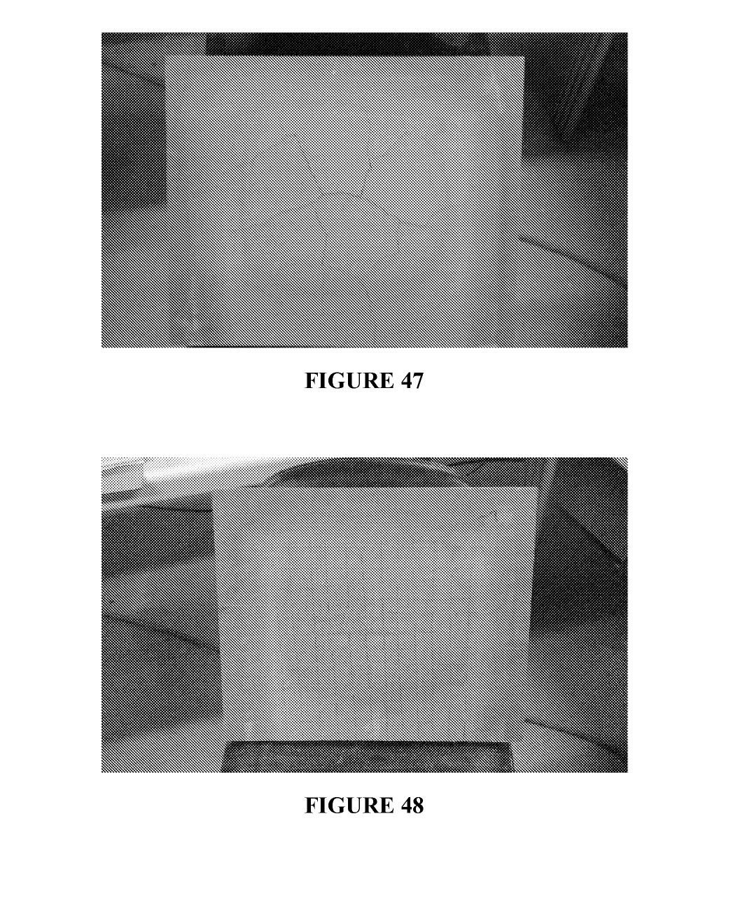

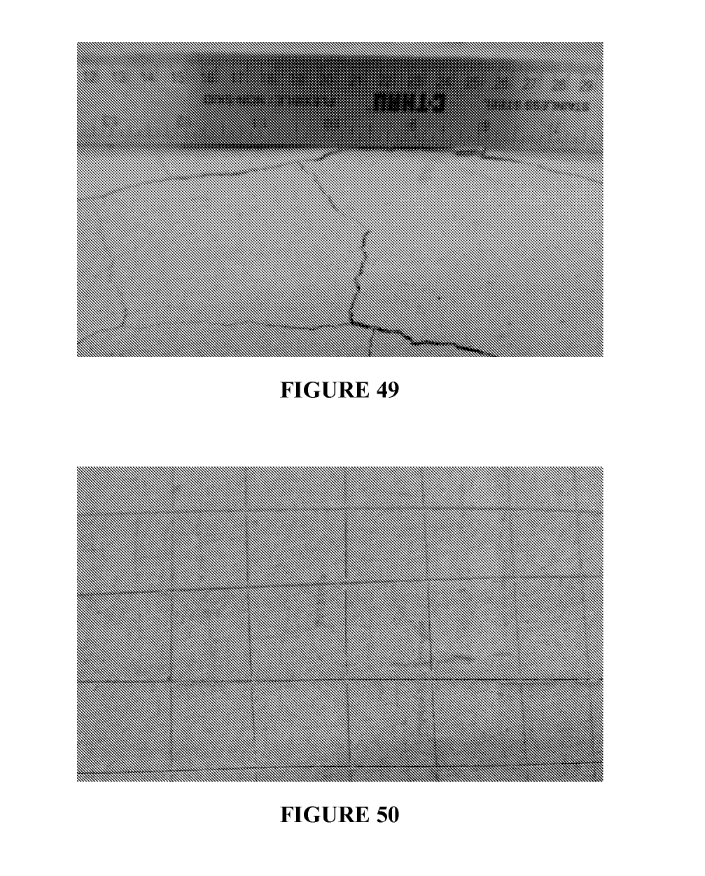

The next testing was conducted on fluidized C-Cast board. We also conducted testing on unrigidized samples, which is not provided herein. The cracking was more pronounced in the rigidized samples shown here. FIG. 47 illustrates the board of Test 26 with no relief slits shows a typical cracking pattern. Based on our rating system, this was 50 cracks at ¼″ deep. FIG. 48 illustrates the board of Test 27 with a 1″×1″ grid cut 5/16″ deep shows no visual cracking. FIG. 49 is a close-up of the board from Test 26 illustrating the cracks more clearly. FIG. 50 is a close-up of the board from Test 27 after firing. This board was cut using a circular knife. The slits are much wider than before firing. The marks on the board are handling rash.

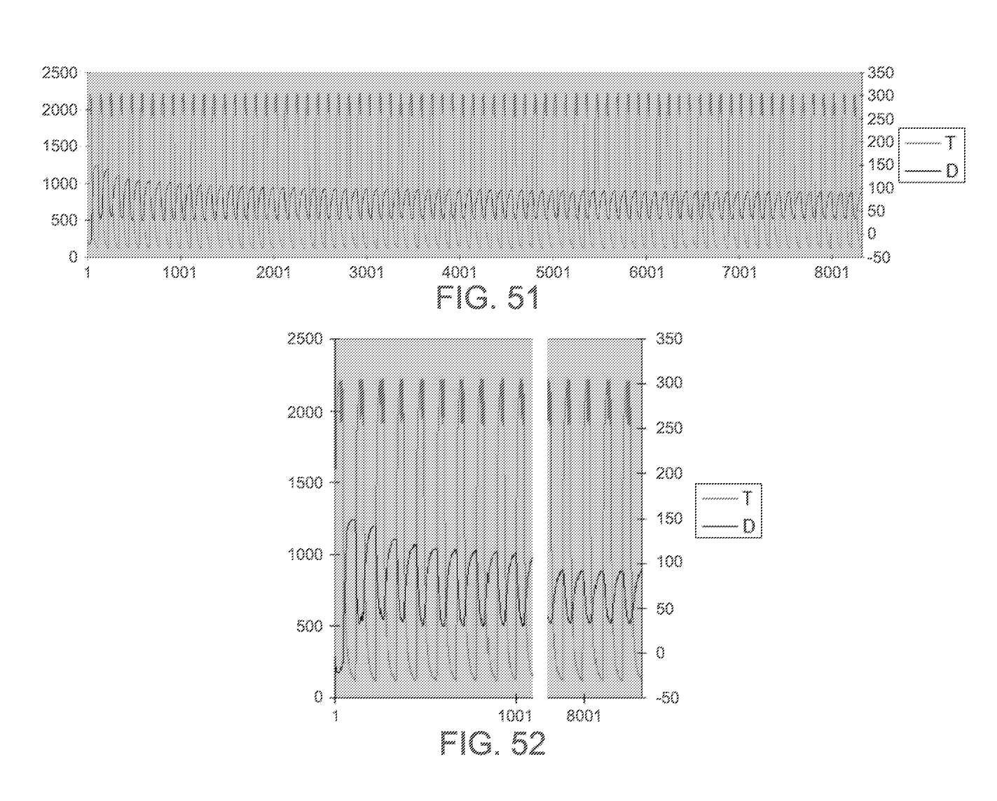

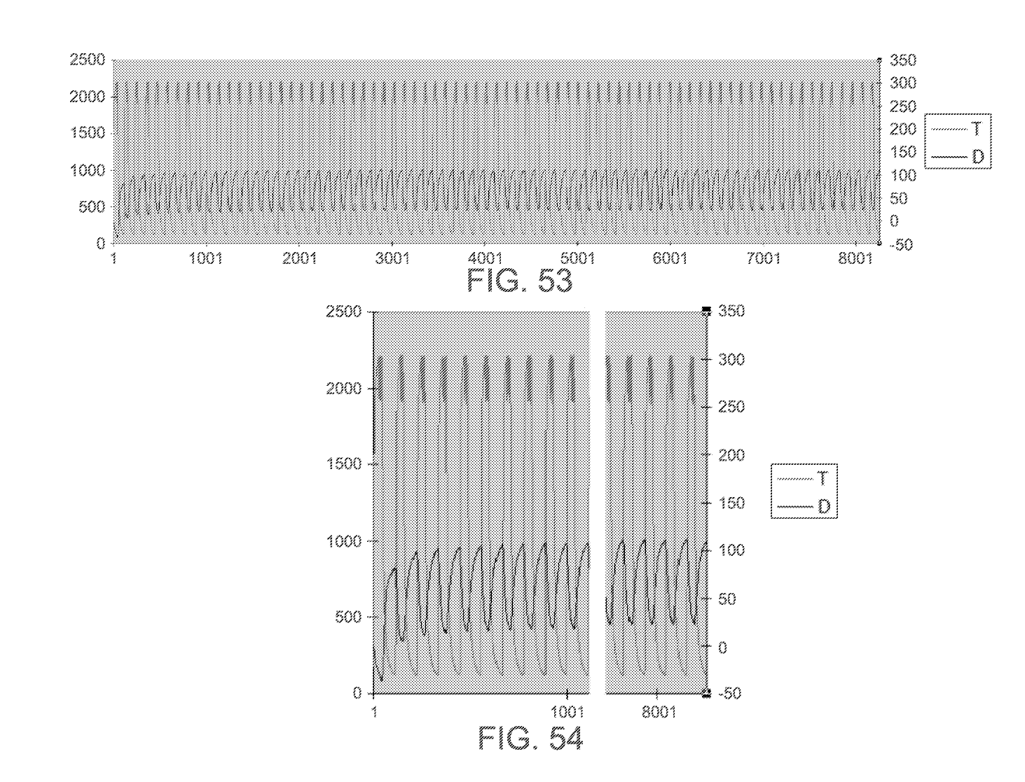

FIGS. 51 and 52 are charts from Test 26, and FIGS. 53 and 54 are charts from Test 27. In Test 26 it would appear that the board relieves the tensions in the first few cycles. In other words, the hoard develops cracks during the first few cycles. This was confirmed by visual examination, The cracks were visible after the first 5 cycles. In the final hour of the test the deflection range is 0.058″ with a maximum deflection of 0.092″ and a minimum deflection of 0.034″. in Test 27 the deflection range rises during the first few cycles, then stays relatively the same throughout the test, This may be interpreted to mean very little cracking is occurring besides the initial grid of slits. In the final hour of the test the deflection range is 0.088″ with a maximum deflection of 0.111″ and a minimum deflection of 0.023″.

### Raypack 717 Tests

Next we tested the Raypak 717 panel for the study. The Raypak 717 panel is a “T” shaped board that is 17.75″ tall, 18.5″ wide with an extra 0.5″ width on each side at the top of the T, and 1.0″ thick.

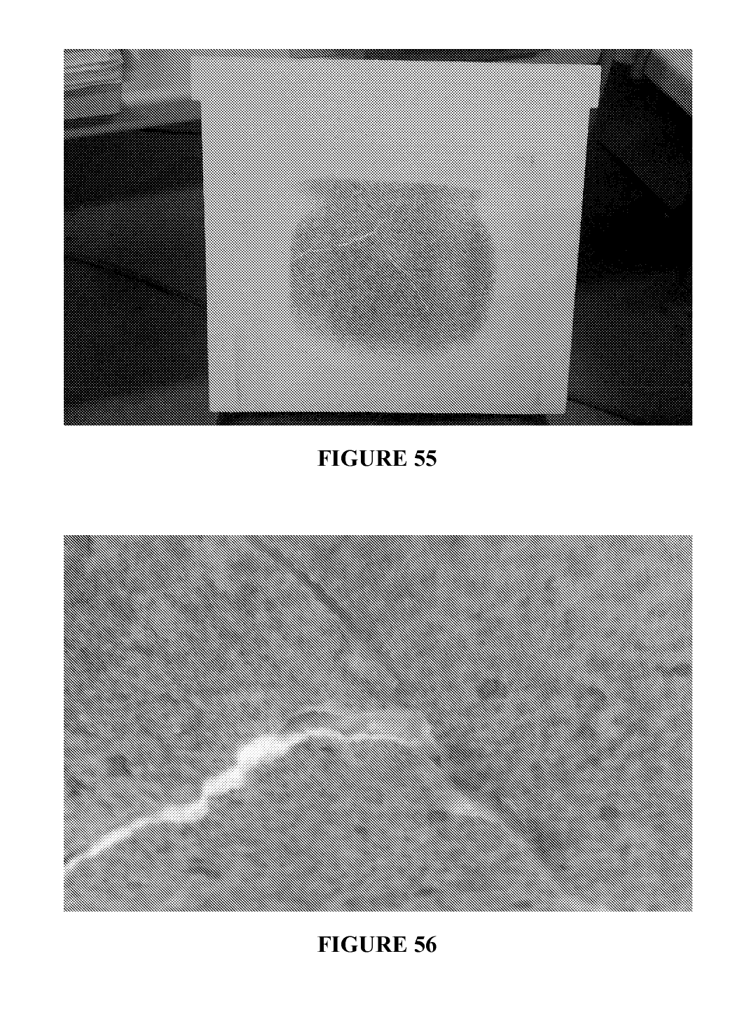

We tested 2 samples with the screen side as the hot face (Tests 28 and 30), and 2 samples with the fill side as the hot face (Tests 29 and 31), We did not cut slit patterns in the 4 samples. The results were extraordinarily consistent, with almost no difference seen between the screen and fill side. Note that the parts are sanded only on the fill side. The screen side is unsanded, and noticeably harder, meaning the silica content is higher on the screen side. The boards from these tests are illustrated in FIGS. 55-58.

We were surprised to see a darkening of the surface on the screen side. This darkening did occur on the fill side, but it was far more pronounced on the screen side. It is believed that unburned hydrocarbons may be combining with the colloidal silica to create silica carbide. Unlike the previous parts, this part is made with no organics, and a higher specific gravity (more colloidal silica). Further analysis will need to be done to determine what is responsible for the color change with certainty. The color change is prominent and repeatable, and correlates directly with the amount of colloidal silica in the hot face, at least in the testing completed at the date of this writing.

All 4 samples were judged to have about 25 cracks with a depth of 0.5.″ Some of the cracks are severe, and may even be deeper. The charts of the deflection data for the Raypak tests, which are not provide herein, are consistent with what has been shown in the first parts application.

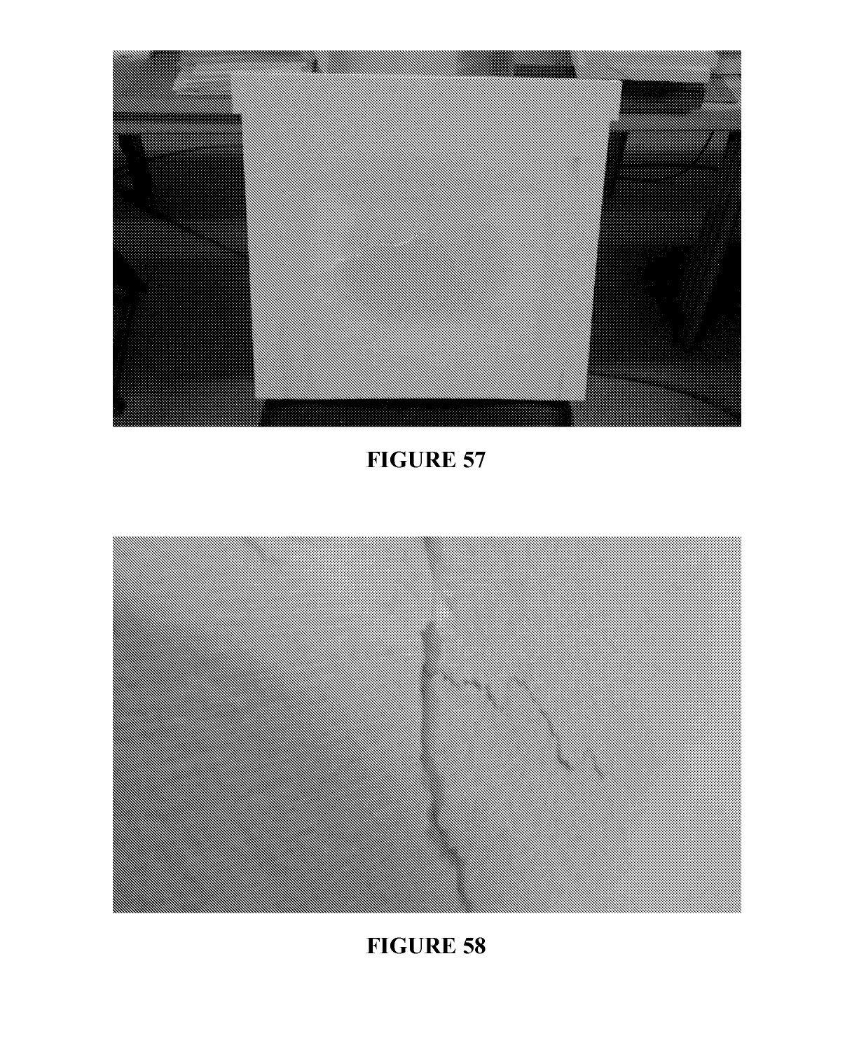

FIG. 55 illustrates the darkened surface, which is perhaps silica carbide forming from unburned hydrocarbons and the high silica content on the screen side. FIG. 56 illustrates one of the deepest and widest cracks that we saw during experimentation. FIG. 57 also shows the darkened pattern, but it is far less pronounces. FIG. 57 illustrates the fill side of the board. The cracks are about the same number and depth as on the screen side. FIG. 58 illustrates deep long cracks from the till side of this board,

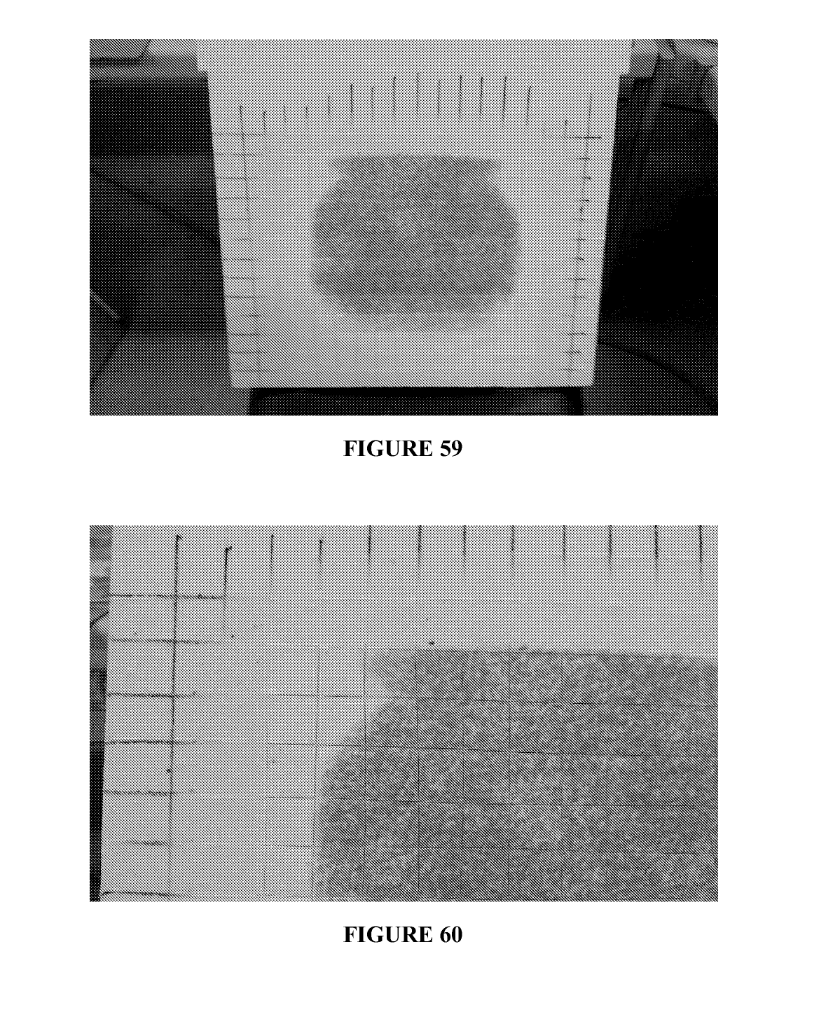

Next, we cut a 1″×1″ grid of slits in the screen side of another sample of the Raypak 717 with the circular knife. The previous 4 samples were run for 75 cycles. We ran this sample for an entire weekend, for 225 cycles. The board showed no cracking. This board is illustrated in FIG. 59, showing no signs of cracking. FIG. 60 is a close-up view. In FIG. 60, it can be seen that the slits have become wider in the area that was exposed to the heat, and are still very narrow in the area that was not exposed to the heat. This clearly shows the residual shrinking of the surface material after being exposed to the heat.

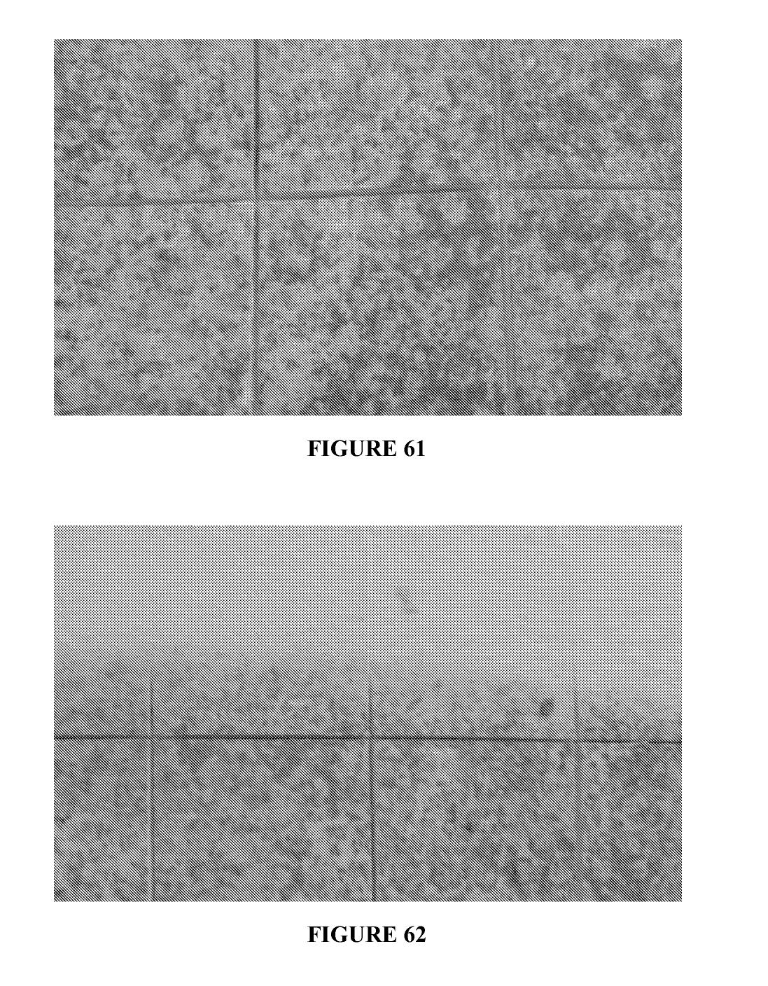

Next, we cut slit patterns of 2″×2,″4″×4,″ and even one with only 2 slits through the center of the heated area. We found that the widening of the slits gets larger as the area of the individual square became larger. We also noticed that the individual squares showed some lifting at one corner which is more pronounced as the squares get larger. FIG. 61 illustrates the board with 2″×2″ grid of slits. Here, we could see some irregularities m the amount of widening of the slits. This suggests additional cracking is occurring along the bottom of some of the slits. The results are far superior to the hoard with no slits, but do indicate that there is an optimal size to the grid pattern that can relieve the amount of tension needed to stop development of additional cracking. FIG. 62 illustrates the 2″×2″ board at the boundary of the heated area showing, widening of the slits.

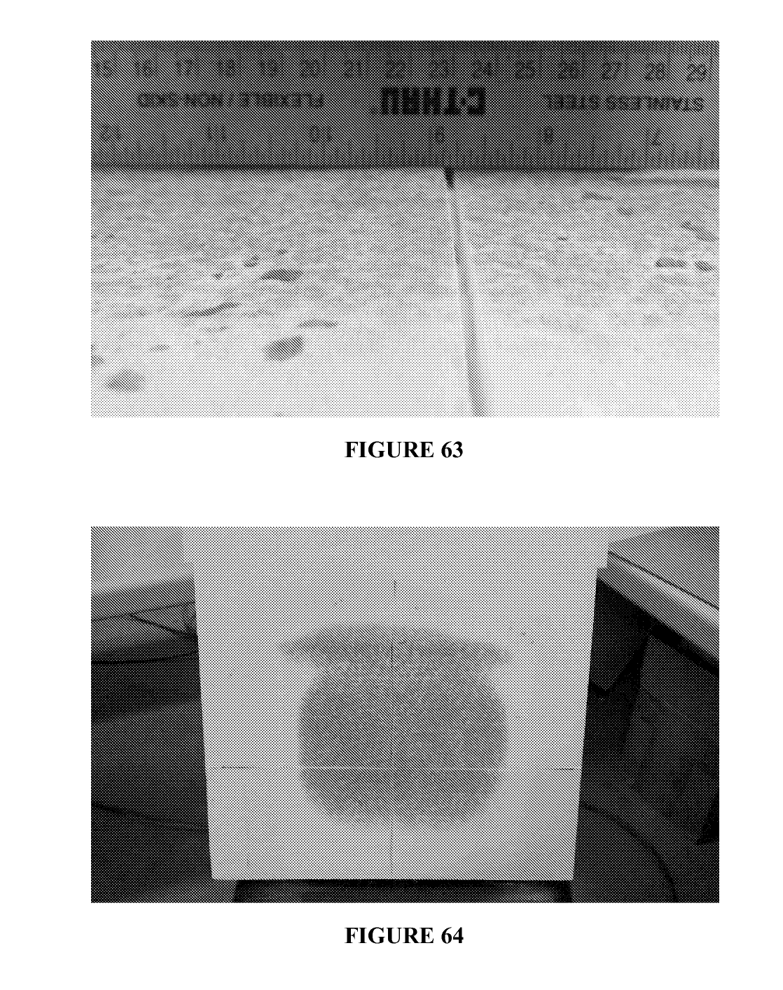

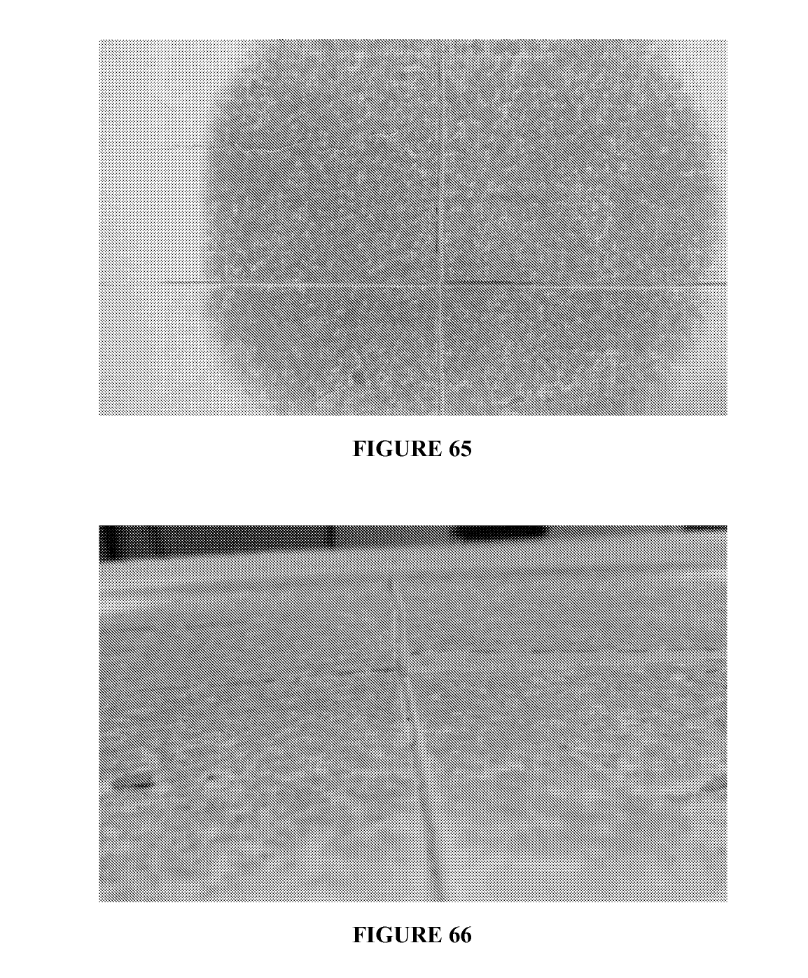

FIG. 63 is a view from Test 33 of a 4″×4″ grid showing that the slits are much wider than in the smaller grid patterns. It also shows how some squares have lifted at one edge or corner. If you look closely, you can see that an additional crack has formed along the bottom of the slit, making the slit deeper than the 5/16″ slit originally cut. FIG. 64 illustrates the hoard from Test 34, where only two slits were cut centered to the heated area of the board. One corner of the squares is lifted. The slits are much wider than originally cut and additional cracking has occurred at the bottom of the slits. In addition, new cracking has occurred in each of the squares. FIG. 65 illustrates the additional cracking that has occurred at the bottom of the slits and on the surface of the squares themselves. FIG. 66 is a close-up view of the hoard from Test 34 showing the lifting of one corner of one of the squares and the additional cracking, that occurred during testing.

In an alternate method of preventing cracking, we tested a sample created by placing a blanket and a ½″ blanket and a ½″ 2300 LD board in the unit, with the blanket as the hot face. In this combination, no cracks formed in the supporting board, This technique appears to also be a viable approach to preventing thermal stress related cracking.

The grid pattern of slits described herein prevents cracking on the body. It is proving to be effective and easy to understand and implement in the lab setting, in one embodiment, the grid patterns can be created on the board in a secondary operation in production. In another embodiment, the grid pattern can be put directly into the dies. Furthermore, implementation of thermal shock relief on complex shapes ma also be achieved utilizing the teachings herein. If a complex shape, like a single piece combustion chamber, is showing problems with thermal expansion related cracking, it will benefit from the treatment described herein.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the invention has been described with respect to specific examples including, presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A body formed of a refractory material comprising:
a first surface and an opposing second surface; and
a pattern of stress relief slits formed into at least one of the first and second surfaces of the body.

2. The body of claim 1 wherein each of the stress relief slits has a depth of approximately inch or more and a width of approximately 1/16 inch or less.

3. The body of claim 1 wherein a ratio of a thickness of the body to a depth of the stress relief slits is between approximately 2:1 and approximately 8:1.

4. The body of claim 1 wherein the pattern of stress relief slits comprises a first set of substantially parallel slits and a second set of substantially parallel slits.

5. The body of claim 4 wherein slits of the first set of substantially parallel slits are substantially perpendicular to slits of the second set of stibstantially parallel slits.

6. The body of claim 4 further comprising a top edge, a bottom edge, a left-side edge and a right-side edge, and wherein each slit of the first set extends from the top edge of the body to the bottom edge of the body, and wherein each slit of the second set extends from of the left-side edge ot the body to the riehtside edge of the body.

7. The body of claim 4 wherein slits of the first and second sets are formed from a plurality of spaced apart slit segments so that each of the slits of the first and second sets is a discontinuous slit.

8. The body of claim 1 wherein the pattern of stress relief slits is a honeycomb pattern.

9. The body of claim 1 wherein the pattern of stress relief slits forms a grid that divides the body into a plurality of rectangles, each of the rectangles having an area of approximately four square inches or less.

10. The body of claim I wherein the first surface of the body is a cold face and the second surface of the body is a hot face, and wherein the pattern of stress relief slits are formed into the hot face of the body.

11. The body of claim 1 wherein the body has a first density at the first surface and a second density at the second surface, the first density being greater than the second density.

12. The body of claim 11 wherein the stress relief slits are formed into the first surface of the body.

13. The body of claim 11 wherein the stress relief slits are formed into the second surface of the body.

14. The body of claim 1 wherein the first and second surfaces are substantially flat.

15. The body of claim 1 wherein the pattern of stress relief slits comprises a first set of slits and a second set of slits that divide the one of the first and second surfaces of the body into a plurality of polygonal sections, each of the polygonal sections having an area.

16. The body of claim 15 wherein the body has a center point, and wherein the areas of the polygonal sections increases with distance from the center point of the body.

17. The body of claim 15 wherein the area of each of the polygonal sections is less than four square inches.

18. A body formed of a refractory material comprising:
a first surface and an opposma second surface; and
a plurality of stress relief slits formed into one of the first and second surfaces of the body, the plurality of stress relief slits dividing the one of the first and second surfaces of the body into a plurality of polygonal sections.

19. The body of claim 18 wherein each of the polygonal sections has an area of four square inches or less.

20. A method of forming a refractory body haying stress relief slits, the method comprising:
a) forming an aqueous slurry comprising water, refractory material fibers, and a binder;
b) dehydrating the aqueous slurry by applying a vacuum to the aqueous slurry thereby forming the refractory body, the refractory body having a first surface and an opposite second surface; and
c) forming a plurality of stress relief slits into at least one of the first and second surfaces of the refractory body.

21. The method of claim 20 wherein the aqueous slurry is formed in a tank, and wherein a die having a cutting pattern is positioned within the tank so that the plurality of stress relief slits are funned into the refractory body during the dehydrating step.

22. The method of claim 21 wherein the plurality of stress relief slits forms a pattern that corresponds with the cutting pattern of the die.

23. The method of claim 20 wherein the plurality of stress relief slits are formed into the one of the first and second surfaces of the refractory body using one of a computer numeric control machine, a knife or a saw after the refractory body is formed in step b).

24. The method of claim 20 wherein each of the stress relief slits has a depth of approximately ⅜ inch or more and a width of approximately 1/16 inch or less.

25. The method of claim 24 wherein a ratio of a thickness of the refractory body to the depth of the stress relief slits is between approximately 2:1 and approximately 8:1.

26. The method of claim 20 wherein the first surface of the refractory body is a screen side and the second surface tot refractory body is a fill side, and wherein the retractor body has a first density at the screen side and a second density at the fill side, the first density being greater than the second density.

27. The method of claim 26 wherein the plurality of stress relief slits are formed into the fill side of the refractory body.

28. The method of claim 26 wherein the plurality of stress relief slits are formed into the screen side of the refractory body.
